(19) United States
(12) Patent Application Publication
(10) Pub. No.: US 2024/0327593 A1
(43) Pub. Date: Oct. 3, 2024

(54) BARRIER COATING COMPOSITION FOR USE IN MANUFACTURING INSULATION PRODUCTS WITH REDUCED HALOGENATED BLOWING AGENTS

(71) Applicant: Owens Corning Intellectual Capital, LLC, Toledo, OH (US)

(72) Inventors: Chase Boudreaux, Canton, OH (US); Jeff Thomas, Mogadore, OH (US); Mitchell Weekley, Tallmadge, OH (US); Christine Heppe, Norton, OH (US); Laura Frazier, Kent, OH (US); Ty Rogers, Akron, OH (US); Saul Salgado, Tallmadge, OH (US)

(21) Appl. No.: 18/617,203

(22) Filed: Mar. 26, 2024

Related U.S. Application Data
(60) Provisional application No. 63/520,359, filed on Aug. 18, 2023.
(60) Provisional application No. 63/492,391, filed on Mar. 27, 2023.

(51) Int. Cl. C08J 9/228; C08J 9/00; C08J 9/12; C08J 9/14; C08J 9/34; C08J 9/36

(52) U.S. Cl. CPC C08J 9/228; C08J 9/0095; C08J 9/122; C08J 9/127; C08J 9/142; C08J 9/146; C08J 9/34; C08J 9/365; C08J 2201/024; C08J 2201/03; C08J 2325/06

(57) ABSTRACT

A coated insulation product with a reduced fluorinated blowing agent concentration, while maintaining acceptable thermal properties (e.g., a 180-day R/in value of at least 4.8), is disclosed. The coated insulation product includes a foam product formed from a foamable composition comprising: a matrix composition; and a blowing agent composition comprising less than 3.5 wt. % of a fluorinated alkene, based on a total weight of the foamable composition. The foam product is coated with 3 g/m² and 225 g/m² of a barrier coating composition on at least one surface. The barrier coating composition includes: 40 wt. % to 99.9 wt. % of a barrier polymer having a minimum degree of crystallinity of 10%; and 0.01 wt. % to 60 wt. % of at least one additive.

### FIELD

This invention relates to a process for forming insulation products and particularly to the manufacture of insulation foams that are formed using a gas blowing agent. This invention provides the use of a barrier coating for retaining gas in insulation products to decrease halogenated blowing agent levels while maintaining desireable thermal and insulation performance.

### BACKGROUND

Polymer foams, such as extruded polymer foams or “XPS” foam, are generally manufactured by melting a polymer matrix composition to form a polymer melt and incorporating one or more blowing agents and other additives into the polymer melt under conditions that provide for the thorough mixing of the blowing agent and the polymer, while preventing the mixture from foaming prematurely, e.g., under pressure. This mixture is then typically extruded through a single or multi-stage extrusion die to cool and reduce the pressure on the mixture, allowing the mixture to foam and produce a foamed product. As will be appreciated, the relative quantities of the polymer(s), blowing agent(s), and additives; the temperature; and the manner in which the pressure is reduced will impact the quality of the resulting foam product. As will also be appreciated, the foamable mixture is maintained under a relatively high pressure until it passes through an extrusion die and is allowed to expand in a region of reduced pressure.

The solubility of conventional blowing agents, such as chlorofluorocarbons (“CFCs”) and certain alkanes, in a polymer melt tends to reduce the melt viscosity and improve cooling of expanded polymer melts. For example, the combination of pentane and a CFC, such as Freon 11 or 12 is partially soluble in polystyrene and has been used for generating polystyrene foams that exhibited a generally acceptable appearance and physical properties such as surface finish, cell size and distribution, orientation, shrinkage, insulation property (R-value), and stiffness.

However, in response to the environmental concerns regarding the use of such CFC compounds, the widespread use and accompanying atmospheric release of such compounds in applications such as aerosol propellants, refrigerants, foam-blowing agents and specialty solvents has recently been drastically reduced or eliminated by government regulation.

The divergence away from the use of CFCs has led to utilization of alternative blowing agents, such as hydrogen-containing chlorofluoroalkanes (HCFCs). HCFCs, however, still contain some chlorine and are therefore said to have an ozone depletion potential (“ODP”).

Another class of blowing agents, hydrofluorocarbons (HFC's), have been used as more ozone friendly options, offering desirable improvements, such as zero ODP and lower (but still potentially significant) global warming potential (GWP). However, these compounds are expensive, tend to be less soluble in polystyrene, and can still have significant GWP. For example, HFC-134a has a GWP of 1430.

Hydrofluoroolefin (“HFO”) blowing agents, which are a type of fluorinated alkene, are more environmentally friendly than traditional halogenated blowing agents. For example, HFOs have reduced ODP and GWP values, compared to traditional fluorocarbon and hydrofluorocarbon blowing agents. However, these compounds tend to be expensive and there exists a need to minimize the amount of these compounds that is required to produce a polymer insulation product with desirable physical properties.

Carbon dioxide is a particularly attractive candidate as a blowing agent, from both an environmental and economic standpoint. Carbon dioxide is inexpensive and has a low (negligible) global warming potential. The technical challenges that have thus far been associated with successfully using carbon dioxide as a blowing agent however, are, significant in light of the relatively low solubility, high diffusivity, and poor processability of carbon dioxide in polystyrene resins. A further technical challenge is that carbon dioxide does not contribute to thermal insulation performance. Thus, although the thermal conductivity of carbon dioxide is comparable to that of HFC-134a, it has previously been found to rapidly diffuse out of foam, which results in a lowered insulation or “R-value”.

Accordingly, there exists a need for methods to produce polymer insulation products with reduced or eliminated usage of halogenated blowing agents as a whole, while maintaining sufficient insulation or “R-values.”

### BRIEF SUMMARY

Various aspects of the present inventive concepts are directed to a coated insulation product with a reduced fluorinated blowing agent concentration, while maintaining acceptable thermal properties (e.g., an 180-day R/in value of at least 4.8). The coated insulation product includes a foam product having a first major surface, an opposing second major surface, and a plurality of minor surfaces extending therebetween, and is formed from a foamable composition comprising: a matrix composition; and a blowing agent composition comprising less than 3.5 wt. % of a fluorinated alkene, based on a total weight of the foamable composition. The foam product is coated with 3 g/m² and 225 g/m² of a barrier coating composition on at least one surface. The barrier coating composition includes: 40 wt. % to 99.9 wt. % of a barrier polymer having a minimum degree of crystallinity of 10%; and 0.01 wt. % to 60 wt. % of at least one additive. The barrier coating composition, as applied, has a surface tension no greater than 60 mN/m.

Further aspects of the present inventive concepts are directed to a coated polymeric insulation product comprising a polymer foam product having a first major surface, an opposing second major surface, and a plurality of minor surfaces extending therebetween. The polymer foam product is formed from a foamable polymer composition comprising a polymer matrix composition; and a blowing agent composition comprising 3 wt. % or less of a fluorinated alkene and at least 1.5 wt. % CO₂, based on a total weight of the foamable composition. The foam product is coated on at least one surface, such as, for example, each surface, with a barrier coating composition in a total amount between 3 g/m² and 225 g/m². The barrier coating composition comprises a semi-crystalline polymer and at least one surfactant and, as applied, has a surface tension no greater than 60 mN/m above a surface energy of the polymer foam product and a viscosity between 50 cP and 5000 cP at 70% solids or less. The coated insulation product has a 180-day R/in value of at least 4.8 and a compressive strength between 10 and 110 psi, measured in accordance with ASTM C578.

In some exemplary aspects, the coated polymeric insulation product has an R-value after 180 days of at least 5.0 per inch.

In any of the exemplary aspects, the blowing agent composition may comprise at least 2 wt. % of CO₂ and less than 3 wt. % of a fluorinated alkene, based on the total weight of the foamable composition. The blowing agent may further comprise methyl formate.

In any of the exemplary aspects, the barrier coating composition may have a viscosity no greater than 5000 cP at 70% solids, such as no greater than 2500 cP at 70% solids, no greater than 2000 cP at 70% solids, no greater than 1500 cP at 70% solids, no greater than 1000 cP at 70% solids, no greater than 750 cP at 70% solids, no greater than 500 cP at 70% solids, no greater than 250 cP at 70% solids no greater than 150 cP at 70% solids, and no greater than 115 cP at 70% solids.

The barrier polymer may comprise, for example, any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

The barrier polymer is preferably at least semi-crystalline and has a minimum degree of crystallinity of 20%, including a minimum degree of crystallinity of 25%, 30%, 35%, 40%, 50%, or 60%.

The barrier coating composition includes at least one additive, such as a wetting agent, rheology modifier, defoaming agent, pH adjuster, fire retardant, antiblocking agent, and UV stabilizer.

In any of the exemplary aspects, the additive may include a rheology modifier present in an amount between 0.01 wt. % and 20 wt. %, based on the total solids content of the barrier coating.

In any of the exemplary aspects, the additive may include at least one wetting agent present in an amount between 0.005 wt. % and 8 wt. %, based on the total solids content of the barrier coating.

Further exemplary aspects of the present inventive concepts are directed to a method of manufacturing a coated insulation product with reduced fluorinated blowing agent content, comprising: mixing a matrix polymer with a blowing agent composition to form a foamable polymer composition; foaming the foamable polymer composition to produce a foam product having a first major surface, an opposing second major surface, and a plurality of minor surfaces extending therebetween; and applying a barrier coating to at least one surface of the foam product in a total amount between 3 g/m² and 225 g/m². The barrier coating is formed from a barrier coating composition comprising: 40 wt. % to 99.9 wt. % of a barrier polymer, based on a total solids content of the barrier coating composition, and 0.01 wt. % to 60 wt. % of at least one additive. The barrier coating composition has a surface tension, as applied, no greater than 60 mN/m, and wherein the coated insulation product has a 180-day R/in value of at least 4.8.

Yet further exemplary aspects of the present inventive concepts are directed to a sheathing system comprising at least one structural portion, having a first surface and an opposing second surface; and at least one coated insulation product adhered to one of the first and second surface of the structural portion. The coated insulation product includes a foam product having a first major surface, an opposing second major surface, and a plurality of minor surfaces extending therebetween, and is formed from a foamable composition comprising: a matrix composition; and a blowing agent composition comprising less than 3.5 wt. % of a fluorinated alkene, based on a total weight of the foamable composition. The foam product is coated with 3 g/m² and 225 g/m² of a barrier coating composition on at least one surface. The barrier coating composition includes: 40 wt. % to 99.9 wt. % of a barrier polymer having a minimum degree of crystallinity of 10%; and 0.01 wt. % to 60 wt. % of at least one additive. The barrier coating composition, as applied, has a surface tension no greater than 60 mN/m. The coated insulation product has an 180-day R/in value of at least 4.8.

The foregoing and other objects, features, and advantages of the general inventive concepts will become more readily apparent from a consideration of the detailed description that follows.

### DESCRIPTION OF THE DRAWINGS

Example embodiments will be apparent from the more particular description of certain example embodiments provided below and as illustrated in the accompanying drawings.

FIG. 1 is a schematic drawing of an exemplary extrusion apparatus useful for practicing methods according to one or more embodiments shown and described herein;

FIG. 2 is a graph showing the thermal conductivity k-value (y-axis) as a function of time (x-axis) for various barrier coating configurations according to Example 1;

FIG. 3 is a graph showing the thermal conductivity k-value (y-axis) as a function of time (x-axis) for various barrier coating configurations according to Example 2;

FIG. 4 is a graph showing the thermal conductivity k-value (y-axis) as a function of time (x-axis) for various barrier coating configurations according to Example 2;

FIG. 5 is a graph showing the thermal conductivity k-value (y-axis) as a function of time (x-axis) for various samples according to Example 3;

FIG. 6 is a graph showing the thermal conductivity k-value (y-axis) as a function of time (x-axis) for various concentrations of the barrier coating composition injected into the extrusion apparatus according to Example 4;

FIG. 7 is a graph showing the thermal conductivity k-value (y-axis) as a function of time (x-axis) for various samples including 0.50 wt. % isobutane and various barrier coating configurations according to Example 4;

FIG. 8 is a graph showing the thermal conductivity k-value (y-axis) as a function of time (x-axis) for various samples according to Example 5;

FIG. 9 is a graph showing the thermal conductivity k-value (y-axis) as a function of time (x-axis) for various concentrations of the barrier coating composition injected into the extrusion apparatus according to Example 6;

FIG. 10 is a graph showing the thermal conductivity k-value (y-axis) as a function of time (x-axis) for various barrier coating configurations with Coating A according to Example 7;

FIG. 11 is a graph showing the thermal conductivity k-value (y-axis) as a function of time (x-axis) for various barrier coating configurations with Coating B according to Example 7;

FIG. 12 is a graph showing the thermal conductivity k-value (y-axis) as a function of time (x-axis) for various samples according to Example 8; and

FIG. 13 is a graph showing the thermal conductivity k-value (y-axis) as a function of time (x-axis) for various samples according to Example 9.

### DETAILED DESCRIPTION

Unless defined otherwise, all technical and scientific terms used herein have the same meaning as commonly understood by one of ordinary skill in the art to which the embodiments belong. Although any methods and materials similar or equivalent to those described herein can be used in the practice or testing of the various embodiments, the preferred methods and materials are described herein. In the drawings, the thickness of the lines, layers, and regions may be exaggerated for clarity. It is to be noted that like numbers found throughout the figures denote like elements. The terms “composition” and “inventive composition” may be used interchangeably herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the insulation product and vice versa; features described herein in relation to the method may be applicable to the foamable composition and vice versa; and features described herein in relation to the insulation product can be applicable to the foamable composition and vice versa.

Every numerical range given throughout this specification and claims will include every narrower numerical range that falls within such broader numerical range, as if such narrower numerical ranges were all expressly written herein.

As used herein, the term “blowing agent” is understood to include physical (e.g., dissolved gaseous agents) or chemical blowing agents (e.g., a gas generated by decomposition). A blowing agent is generally added to a molten polymer, e.g., in an extruder, and under the proper conditions, to initiate foaming to produce a foamed product. The blowing agent expands the resin and forms cells (e.g., open or closed pores). As the resin hardens or cures, foam is produced with either the blowing agent trapped in the cells or ambient air displaces the blowing agent in the cells. The blowing agents discussed herein preferably consist of or comprise environmentally acceptable blowing agents (i.e., “low GWP” blowing agents) as would be recognized by one of ordinary skill in the art. Such low GWP blowing agents have a GWP value of no greater than 500, such as GWP values of no greater than 250, no greater than 200, no greater than 150, no greater than 125, no greater than 100, no greater than 75, no greater than 50, no greater than 25, no greater than 20, no greater than 15, no greater than 10, no greater than 8, no greater than 5, and no greater than 3.

As used herein, unless specified otherwise, the values of the constituents or components of the blowing agent or other compositions are expressed in weight percent or % by weight of each ingredient in the composition.

As it pertains to the present disclosure, “closed cell” refers to a foam having a plurality of cells, at least 95% of which are closed. However, in the present application, cells may be “open cells,” closed cells, or a mixture thereof (i.e., certain embodiments disclosed herein may exhibit an “open cell” foam structure or a blend of open cells and closed cells).

The term “R-value” is the unit used to measure the effectiveness of thermal insulation and is the reciprocal of thermal conductivity, which for foam board materials having substantially parallel faces, is defined as the rate of flow of thermal energy (BTU/hr or Watt) per unit area (square foot=ft² or square meter=m²) per degree of temperature difference (Fahrenheit or Kelvin) across the thickness of the slab material (inches or meters). The thermal performance of a polymeric insulation product is based on the R-value of the insulation product, which is a measure of the product's resistance to heat flow. The R-value is defined by Equation (1):

$$R = {T}_{1} / k \qquad Equation ( 1 )$$

where “T₁” is the thickness of the insulation product expressed in inches, “k” is the thermal conductivity of the insulation product expressed in BTU·in/hr·ft²·° F., and “R” is the R-value of the insulation expressed in hr·ft²·° F./BTU.

As used herein, an insulation product's thickness (T₁) may be determined in accordance with ASTM C167-18 and both k-value and area weight (in 1 b/ft²) may be determined in accordance with ASTM C578 or ASTM C177-19.

The present disclosure relates to a foam and foam insulation products, such as extruded or expanded polymer foams, formed from a composition that contains a foamable material, a blowing agent composition, and a barrier coating or barrier additive that stops or slows the diffusion rate of the blowing agent composition, thereby enabling the use of a lower concentration of conventional halogenated blowing agents, such as hydrofluorocarbons (HFCs), hydrochlorofluorocarbons, hydrofluoroethers, hydrofluoroolefins (HFOs), and hydrochlorofluoroolefins (HCFOs), and replacing this removed amount of halogenated blowing agent with carbon dioxide. The insulation foam produced surprisingly achieves an R-value comparable to that of insulation products not including the subject barrier coating or additive and including a convention concentration of fluorinated blowing agent.

Although the subject disclosure primarily describes polymer foam insulation, it is to be appreciated that the present inventive concepts are similarly applicable to non-polymer foam insulation, such as cellular glass insulation, aerogel insulation, etc. Additionally, although the below disclosure provides an exemplary method for forming an insulation product (extrusion method), it is to be appreciated that other methods for forming insulation products are contemplated herein, such as spray foam, expanded foam, and the like.

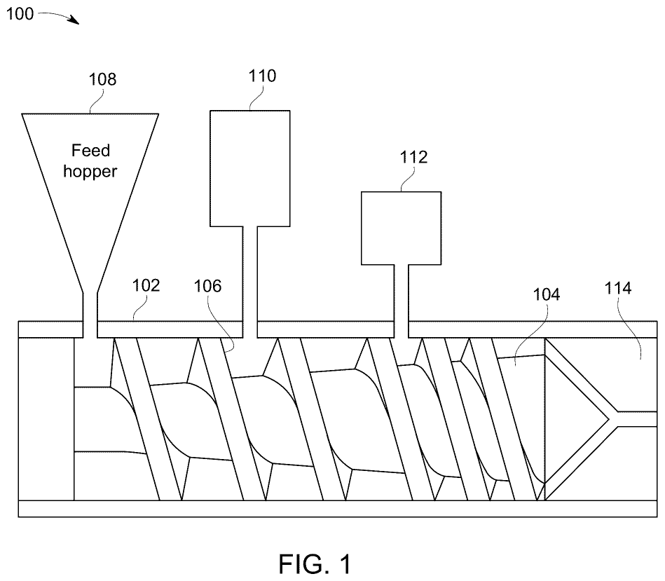

FIG. 1 illustrates an extrusion apparatus 100 useful for the production of polymer insulation products (e.g., XPS), in accordance with the present inventive concepts. The extrusion apparatus 100 can comprise a single or double (not shown) screw extruder including a barrel 102 surrounding a screw 104 on which a spiral flight 106 is provided. The screw 104 is surrounded by a barrel 102. The spiral flight 106 is configured to compress, and thereby heat, material introduced into the screw extruder. As illustrated in FIG. 1, the polymer composition may be conveyed into the screw extruder as a flowable solid, such as beads, granules or pellets, or as a liquid or semi-liquid melt, from one or more (not shown) feed hoppers 108.

As the basic polymer composition advances through the screw extruder, the decreasing spacing of the flight 106 defines a successively smaller space through which the polymer composition is forced by the rotation of the screw. This decreasing volume acts to increase the temperature of the polymer composition to obtain a polymer melt (if solid starting material was used) and/or to increase the temperature of the polymer melt.

As the polymer composition advances through the screw extruder 100, one or more ports may be provided through the barrel 102 with associated apparatus 110, 112 for injecting one or more blowing agents and optional additives into the polymer composition. In some embodiments, a barrier coating composition may be added through one or more of the ports, as will be described in greater detail below. Once the blowing agent(s) have been introduced into the polymer composition, the resulting mixture is subjected to some additional blending sufficient to distribute each of the components generally uniformly throughout the polymer composition to obtain a polymer foamable composition.

The polymer foamable composition is then forced through an extrusion die 114 and exits the die into a region of reduced pressure (which may be below atmospheric pressure), thereby allowing the blowing agent to expand and produce a polymer foam material. This pressure reduction may be obtained gradually as the extruded polymer foamable composition advances through successively larger openings provided in the die or through some suitable apparatus (not shown) provided downstream of the extrusion die for controlling to some degree the manner in which the pressure applied to the polymer foamable composition is reduced. The polymer foam material may also be subjected to additional processing such as calendaring, water immersion, cooling sprays or other operations to control the thickness and other properties of the resulting foam insulation product (referred to herein interchangeably as “foam product,” “foam insulation product,” and/or “insulation product”).

As mentioned above, the present inventive concepts are directed to the discovery that the application of a novel barrier coating composition to at least one surface of a foam insulation product can reduce blowing agent diffusion and increase the foam's thermal insulation performance. In any of the exemplary embodiments, the barrier coating composition may be applied to one or more surfaces of the insulation product. The insulation product has two opposing major surfaces (e.g., a top surface and an opposing bottom surface) and a plurality of minor surfaces extending therebetween (e.g., two opposing side surfaces and two opposing edge surfaces). The barrier coating composition can be applied, for example, to one or more surfaces of the insulation product using any one of a variety of coating methods. For example, the barrier coating composition can be applied via a roller, brush, spray coating method, dip coating, spin coating, flow coating, curtain coating, and the like. Other coating methods known and used in the art may be employed, and are contemplated within the subject disclosure.

The barrier coating composition is preferably applied to the insulation product as soon as possible post-production (i.e., post extrusion, expansion, or other foam production method), such as for example, within a period of less than 12 hours of production, and particularly within a period of less than 6 hours, less than 3 hours, less than 2 hours, less than 1 hour, or less than 30 minutes of production. According to any aspect, the barrier coating may be applied to the product immediately post-production. The coating is then dried to form a barrier coating on at least one surface of the insulation product. Although described as being applied to one or more major surfaces of the insulation product, it should be appreciated that the barrier coating composition can additionally, or alternatively be applied to one or more minor surfaces of the insulation product. In any of the embodiments, the barrier coating composition may be applied to each surface of the insulation product. For example, the barrier coating composition can be applied to one or more edges of the resulting insulation product in addition to or alternatively to the top and/or bottom surfaces of the resulting polymer insulation product. The barrier coating may be applied such that it forms a continuous coating on the one or more surfaces of the insulation product, or the barrier coating may form only a partial, discontinuous coating on one or more surfaces. In any of the exemplary aspects, the barrier coating may be in the form of a film.

In any of the exemplary embodiments, the barrier coating composition may be applied directly to the surface of the insulation product with no intervening layers between the insulation product surface and the barrier coating composition. Additional coating layers, including additional coating layers of the barrier coating composition may optionally be applied on the first barrier coating composition layer. However, it is contemplated that, in some instances, one or more optional primer layers can be applied between the barrier coating composition and the surface of the insulation product such that the barrier coating composition is applied indirectly to the surface of the insulation product (e.g., the barrier coating composition is applied to a primer layer on the surface of the insulation product).

In any of the exemplary aspects, the barrier coating composition may act as an adhesive to secure one or more additional layers to the insulation product.

Further, it is contemplated that, in any of the exemplary embodiments, the barrier coating composition described herein may be incorporated into the foamable composition. For example, instead of applying the barrier coating composition as a coating on at least one surface of the insulation product, (or in addition to) the barrier coating composition can be injected into the screw extruder. In embodiments in which the polymer of the barrier coating composition is a resin, the polymer may be introduced into the feed hopper in pellet form. It should be appreciated that, when injected into the extruder, certain properties of the barrier coating composition may differ from those of a barrier coating composition intended for coating on a surface of the polymer insulation product, including, but not limited to, the viscosity of the coating composition and the solids loading of the barrier coating.

The barrier coating composition may comprise a dispersion, solution, or emulsion comprising one or more polymers. The polymers may comprise one or more barrier polymers, such as poly(vinylidene chloride) (PVdC) and PVdC-based copolymers, polyvinyl alcohol (PVOH), poly(ethylene-co-vinyl alcohol) (EVOH), poly(vinylidene fluoride) (PVdF), polyurethane, styrene butadiene (SBR), polyvinyl chloride (PVC), poly(acrylates) and copolymers, polyamides (e.g., Nylon-6), polyesters (e.g., PET), polystyrene (PS), polyglycolic acid (PGA), poly(ethylene 2,5-furandicarboxylate) (PEF), poly(butylene succinate) (PBS), bio-based ethylene (Bio-PE), wax, such a natural wax (carnauba and montan wax), petroleum-based wax (paraffins, microcrystalline wax), or synthetic wax, derived from petroleum distillates or residues (polyethylene, polypropylene, Fischer-Tropsch wax), and combinations or copolymers thereof. Other polymers may be incorporated, provided they are capable of imparting, or at least no inhibiting, gas barrier properties to the coating.

In any of the exemplary embodiments, the barrier polymer may be a homopolymer or a copolymer comprising one or more co-monomers, such as, without implied limitation, vinyl chloride; vinyl alcohols; vinyl esters, such as, for example, vinyl acetate; vinyl ethers; acrylic acids; acrylic esters; acrylamides; methacrylic acids; methacrylic esters; methacrylamides; acrylonitrile; N-vinylpyrrolidone; methacrylonitrile; styrene; styrene derivatives; butadiene; olefins, such as, for example, ethylene and propylene; itaconic acid; and maleic anhydride. Such co-monomers also include copolymerizable surfactants such as sodium salt of an allyl ether sulfonate (e.g., odium 1-allyloxy-2-hydroxypropyl sulfonate), 2-acrylamido-2-methylpropanesulphonic acid (AMPS) or one of its salts, e.g. the sodium salt, 2-sulphoethylmethacrylic acid (2-SEM) or one of its salts, e.g. the sodium salt, and the phosphate ester of methacrylate-terminated polypropylene glycol or one of its salts, e.g. the sodium salt, poly(ethylene oxide) methyl ether acrylate (PEOA), poly(ethylene oxide) methyl ether methacrylate (PEOMA).

In any of the exemplary embodiments, the barrier polymer is at least a semi-crystalline polymer, with a minimum degree of crystallinity of 5%. Particularly, a barrier polymer having a degree of crystallinity of at least 10%, or at least 15%, or at least 20%, or at least 25%, or at least 30% provides a barrier coating composition with sufficient barrier properties. In any of the exemplary embodiments, the barrier polymer may comprise a degree of crystallinity of at least 20%, such as at least 25%, at least 30%, at least 35%, at least 40%, at least 45%, at least 50%, at least 55%, at least 60%, at least 65%, at least 70%, at least 75%, at least 80%, at least 85%, at least 90%, and at least 95%.

The barrier polymer can be added in solid (e.g., resin) form, or in melted (e.g., liquid) form as a dispersion, solution, or emulsion (the “barrier polymer material”). When the barrier polymer is added in the form of a dispersion, the dispersion may be an aqueous dispersion (e.g., the polymer is dispersed in water), or a solvent-based dispersion.

When provided in the form of a dispersion, the barrier polymer may be present in a solids content of about 20 wt. % to about 100 wt. % based on the weight of the dispersion, including, for example, a solids contents of from about 25 wt. % to about 85 wt. %, from about 30 wt. % to about 75 wt. %, from about 35 wt. % to about 65 wt. %, from about 40 wt. % to about 60 wt. %, from about 45 wt. % to about 56 wt. %, or any other endpoints or subrange included therein.

The barrier polymer may also be characterized by the amount of barrier polymer present in the barrier coating composition, based on the total amount of solids present in the barrier coating composition. For example, the polymer may be included in an amount of from about 40 wt. % to about 100 wt. %, based on the total amount of solids present in the barrier coating composition, including, for example, from about 50 wt. % to about 98 wt. %, from about 60 wt. % to about 96 wt. %, from about 70 wt. % to about 93 wt. %, and from about 75 wt. % to about 91 wt. %, including any other endpoints or subrange included therein.

The barrier coating composition may comprise one or more additives, whether added as part of the barrier polymer material or directly to the composition, such as, for example, processing aids; surfactants (wetting agents); rheology modifiers; flame retardants; defoaming agents, such as emulsions and/or dispersions of mineral, paraffin, or vegetable oils; silicone; dispersions of polydimethylsiloxane (PDMS) fluids; pH adjusters; UV stabilizers; and silica which has been hydrophobized with polydimethylsiloxane or other materials.

Exemplary rheology modifiers may include, for example, glycerol, 1,2,4-butanetriol, 1,4-butanediol, 1,2-propanediol, 1,3-propanediol, poly(ethylene glycol), clays, fumed silica, cellulose and derivatives thereof, polysaccharides, alkali-swellable polymers (ASE, HASE, HMASE) (e.g., Solthix™ A100), hydrophobically modified urethane associative polymers (HEUR) (e.g., Rheobyke® 7600, 7610, available from BY K, Borchi® Gel L75N, available from Milliken), alkali-acrylic emulsions, modified vinylpyrrolidone-vinylacetate copolymer thickener (e.g., Rheovis® VP 1231, available from BASF), polyurea, polyamides and calcium sulfonates, and combinations thereof.

The viscosity of the barrier coating composition is important for ensuring the coating can be applied in the particular method intended, such as spraying, painting, dip coating, etc. Thus, a rheology modifier may be included in such a concentration to achieve a coating viscosity of less than about 5000 cP at about 75° F. and 70% solids or less, including less than about 4000 cP at about 75° F. and 70% solids or less, less than about 3500 cP at about 75° F. and 70% solids or less, less than about 3000 cP at about 75° F. and 70% solids or less, less than about 2500 cP at about 75° F. and 70% solids or less, less than about 2000 cP at about 75° F. and 70% solids or less, less than about 1500 cP at about 75° F. and 70% solids or less, less than about 1000 cP at about 75° F. and 70% solids or less, less than about 750 cP at about 75° F. and 70% solids or less, less than about 500 cP at about 75° F. and 70% solids or less, less than about 250 cP at about 75° F. and 70% solids or less, less than about 200 cP at about 75° F. and 70% solids or less, less than about 150 cP at about 75° F. and 70% solids or less, less than about 100 cP at about 75° F. and 70% solids or less, less than about 300 cP at about 75° F. at 70% solids or less, and less than about 200 cP at about 75° F. and 70% solids or less. In any of the exemplary embodiments, the viscosity of the barrier coating composition may be no greater than 5000 cP at about 75° F. and 70% solids or less, such as between 50 cP and 3750 cP, between 75 cP and 3000 cP, between 90 cP and 2500 cP, between 95 cP and 2000 cP at about 75° F. and 70% solids, between 100 cP and 1500 cP at about 75° F. and 70% solids, and between 150 cP and 1000 cP at about 75° F. and 70% solids, including all subranges and endpoints therebetween. Such a viscosity is particularly important to achieve a sprayable coating composition.

Thus, in various aspects of the present inventive concepts, the rheology modifier is included in the barrier coating composition in an amount between 0 and 20 wt. %, based on the weight of the total solids content of the barrier coating composition, including between 0.01 wt. % and 15 wt. %, between 0.05 wt. % and 12 wt. %, between 0.1 wt. % and 10 wt. %, between 0.15 wt. % and 8 wt. %, between 0.2 wt. % and 6 wt. %, between 0.25 wt. % and 4 wt. %, and between 0.3 wt. % and 2 wt. %, including all subranges and endpoints therebetween.

As mentioned above, the barrier coating composition may include a pH adjuster in an amount sufficient to adjust the pH to a desired level. For example, organic and/or inorganic bases, can be included to increase the pH of the barrier coating composition. In some exemplary embodiments, the bases may be a volatile or non-volatile base. Exemplary volatile bases include, for example, ammonia and alkyl-substituted amines, such as methyl amine, ethyl amine or 1-aminopropane, dimethyl amine, and ethyl methyl amine. Exemplary non-volatile bases include, for example, sodium hydroxide, potassium hydroxide, sodium carbonate, and t-butylammonium hydroxide.

The pH of the barrier coating composition preferably has a pH between 2 to 10, including pH values between 3 and 8, and between 4 and 7. In any of the embodiments disclosed herein, the barrier coating composition may have a neutral pH between 6 and 7.

In various aspects of the present inventive concepts, the pH adjuster is included in the barrier coating composition in an amount between 0 and 15 wt. %, based on the weight of the total solids content of the barrier coating composition, including between 0.05 wt. % and 12 wt. %, between 0.1 wt. % and 10 wt. %, between 0.25 wt. % and 8 wt. %, between 0.4 wt. % and 6 wt. %, between 0.5 wt. % and 4 wt. %, between 0.75 wt. % and 2.5 wt. %, and between 0.9 wt. % and 2 wt. %, including all subranges and endpoints therebetween.

As the barrier coating composition may be applied to one or more surfaces of a foam insulation product, it is important that the coating is able to sufficiently wet and spread over the foam surface to achieve a uniform, consistent coating. To achieve sufficient wetting, the surface tension of the barrier coating composition needs to be tailored to the surface energy of the foam product. Namely, the barrier coating composition is particularly formulated to possess a surface tension no greater than 40 mN/m above the surface energy of the foam product, including no greater than 15 mN/m, no greater than 10 mN/m, no greater than 8 mN/m, no greater than 5 mN/m, no greater than 2.5 mN/m, and no greater that 1 mN/m above the surface energy of the foam product. In any of the exemplary embodiments, the barrier coating composition has a surface tension approximately (+/−5%) equal to the surface energy of the foam product. In any of the exemplary embodiments, the barrier coating has a surface tension that is equal to or less than the surface energy of the foam product.

The insulation product may have a surface energy of approximately 35 mN/m to 55 mN/m, including approximately 37 mN/m to 53 mN/m, 39 mN/m to 51 mN/m, and 40 mN/m to 50 mN, including all endpoints and subranges therebetween.

In various aspects of the present inventive concepts, the barrier coating composition may have a surface tension that is equal to or less than the surface energy of the insulation product. The surface tension of the barrier coating composition may be approximately 30 mN/m to 55 mN/m, including approximately 34 mN/m to 50 mN/m, 36 mN/m to 48 mN/m, and 38 mN/m to 46 mN, including all endpoints and subranges therebetween. In this or other aspects, the barrier coating composition may have a surface tension of no greater than 50 mN/m, no greater than 48 mN/m, no greater than 47 mN/m, and no greater than 46 mN/m.

In order to tailor the surface tension of the barrier coating composition, the coating may include one or more wetting agents, such as surfactants, oils, and the like. The surfactant(s) may include any one or more of ionic surfactants, non-ionic surfactants, cationic surfactants, amphoteric surfactants, and mixtures thereof. The term “amphoteric” surfactant is often used interchangeably with the term “zwitterionic” surfactant, i.e. each term has the identical meaning of surfactants having both cationic and anionic centers attached to the same molecule.

In accordance with the present disclosure, the one or more surfactants may comprise, or consist of, one or more anionic surfactants. Exemplary anionic surfactants include sulfates (e.g., alkyl sulfates, ammonium lauryl sulfate, sodium lauryl sulfate (SLS), alkyl ether sulfates, sodium laureth sulfate, and sodium myreth sulfate); sulfonates (e.g., dioctyl sodium sulfosuccinate, perfluorooctanesulfonate, perfluorobutanesulfonate, alkyl sulfonates, and alkyl benzene sulfonates); carboxylates (e.g., alkyl carboxylates, fatty acid salts (soaps)), sodium lauroyl sarcosinate, carboxylate fluorosurfactants, perfluoronanoate, and perfluorooctanoate); phosphates (e.g., alkyl aryl ether phosphate, alkyl ether phosphate, mono- and di-phosphate esters of nonyl phenol ethoxylate, phosphate esters of tridecyl alcohol ethoxylate, phosphate esters of isodecyl ethoxylate, and other phosphate esters of aromatic ethoxylates and aliphatic ethoxylates, phosphate esters of C10-C16 alkyl ethoxylates/propoxylates); salts of fluorinated fatty acids; Silicones; stearates; and the like and mixtures thereof.

In accordance with the present disclosure, the one or more surfactants may comprise, or consist of, one or more cationic surfactants. Exemplary cationic surfactants include alkylamine salts such as laurylamine acetate; permanently charged quaternary ammonium cations (e.g., alkyltrimethylammonium salts, cetyl trimethylammonium bromide, cetyl trimethylammonium chloride, cetylpyridinium chloride, and benzethonium chloride); and quaternary ammonium salts (e.g., lauryl trimethyl ammonium chloride and alkyl benzyl dimethylammonium chloride), polyoxyethylenealkylamines, and the like and mixtures thereof.

In accordance with the present disclosure, the one or more surfactants may comprise, or consist of, one or more amphoteric surfactants. Exemplary amphoteric surfactants include alkyl betaines, such as lauryl-betaine; alkylamidopropylbetaine (APB); cocamidopropyl betaine; alkylamidopropylamine N-oxide (APAO); alkyldimethylamine N-oxide (AO), cocoamphoacetate; cocoamphodiacetate; and the like and mixtures thereof.

In accordance with the present disclosure, the one or more surfactants may comprise, or consist of, one or more nonionic surfactants. Suitable nonionic surfactants may include block copolymers based on polyethylene glycol and polypropylene glycol; polyethers (e.g., ethylene oxide and propylene oxide condensates, which include straight and branched chain alkyl and alkaryl polyethylene glycol and polypropylene glycol ethers and thioethers); alkyl polyglucosides (e.g., glycerol fatty acid esters, polyoxyethylene glycerol fatty acid esters, polyoxyethylene sorbitan fatty acid esters, polyethylene glycol fatty acid esters and polyoxyethylene polyoxypropylene block copolymers with terminal hydroxyl groups and combinations thereof); alkylphenoxypoly(ethyleneoxy)ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

Exemplary surfactants may include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), SURFADOL™ 420 (which is a 2,4,7,9-tetramethyl-5-decyne-4,7-diol ethoxylate), Surfynol 465 (an ethoxylated 2,4,7,9-tetramethyl 5 decyn-4,7-diol), Triton™ GR-PG70 (1,4-bis(2-ethylhexyl) sodium sulfosuccinate), Triton™ CF-10 (poly(oxy-1,2-ethanediyl), alpha-(phenylmethyl)-omega-(1,1,3,3-tetramethylbutyl)phenoxy), Hydropalat® WE 3135, which is a Difunctional block copolymer surfactant terminating in primary hydroxyl groups, and Hydropalat® WE 3694 and/or Hydropalat® WE 3323, a nonionic wetting agent.

The wetting agent(s) may be present in the barrier coating composition in an amount from 0 to about 15% by weight, such as, for example, from about 0.001% to about 8% by weight, from about 0.005% by weight to about 7.5% by weight, from about 0.01% by weight to about 7% by weight, from about 0.05% by weight to about 6.5% by weight, from about 0.075% by weight to about 6% by weight, from about 0.09% by weight to about 5.5% by weight, from about 0.1% by weight to about 5% by weight, from about 0.15% to about 4% by weight, or from about 0.2% to 2.5% by weight, based on the total solids content in the barrier polymer material, including all subranges and endpoints therebetween.

Optionally, the barrier coating composition further comprises one or more film-forming additives. Film-forming additives can include, by way of example and not limitation, graphene, nanoclays, or inorganic layered particles. Suitable film-forming additives can include, by way of example and not limitation, cellulose nanocrystals (CNC), organosilane, perfluoroalkyl ethyl methacrylate (PPFEMA), ormocers, biowaxes/waxes, nanoclays/clays, silicon oxide (SiOₓ), aluminum oxide films (Al₂O₃), graphene/graphene oxide, molymbenum disulfide (MoS₂), tungsten disulfide (WS₂), niobium selenide (NbSe₂), hexagonal boron nitride (hBN), and combinations thereof. The film-forming additives aid the barrier coating composition in forming a continuous film on the surface of the insulation product and may contribute to the barrier properties of the barrier coating. When included, the film-forming additives can be included in the barrier coating composition in an amount of from 0.1 wt. % to 50 wt. %, including from 0.5 wt. % to 25 wt. %, from 1 wt. % to 20 wt. %, or from 5 wt. % to 15 wt. % of the barrier coating composition based on a total amount of solids present in the composition.

Optionally, the barrier coating composition may include one or more fillers, such as platelet-type additive, such as graphene, nanoclay, inorganic layered particles, including mica, talc, and aluminum flake, or combinations thereof. In some exemplary embodiments, the one or more fillers may be included in at least 0.25 wt. % of the barrier coating composition, based on a total amount of solids present in the composition. The one or more fillers may be included in about 0.5 wt. % to about 50 wt. %, including about 1 wt. % to about 35 wt. %, about 5 wt. % to about 30 wt. % and about 10 wt. % to about 25 wt. % of the barrier coating composition based on a total amount of solids present in the composition, including any endpoints and subranges therebetween.

The barrier coating composition may optionally further comprise one or more other additives, such as UV absorbers/stabilizers, fire retardants, defoamers, anti-blockers, pigments, oils, matting agents, etc. Exemplary UV absorbers/stabilizers may include, for example, benzotriazoles, polypropylene, antioxidants, hindered amine light stabilizers (HALS), and the like (e.g. BASF Tinuvin® 479-DW ECO, which is an aqueous preparation of a triazine-based UV absorber from BASF, 2-[3(2H-benzotriazol-2-yl)-4-hydroxy phenyl]ethyl methacrylate from Sigma Aldrich, Lowilite™ 26, which is a benzotriazole UV light absorber from SI Group, liquid hydroxyphenyl-triazine (HPT), such as Omnistab® UV400, available from Partner in Chemicals; a HALS stabilizer based on amino ether functionality, such as Omnistab® LS123, available from Partner in Chemicals and benzotriazole UV absorbers, such as Eversorb® 81 and Eversorb® 95, available from Everlight USA, Inc.). If present, the UV absorber/stabilizer may be included in the barrier coating composition in an amount from 0 wt. % to 10 wt. %, including from 0.5 wt. % to 8 wt. %, from 0.75 wt. % to 6 wt. %, from 1 wt. % to 5.5 wt. %, from 1.5 wt. % to 5 wt. %, from 1.75 wt. % to 3.5 wt. %, or from 2 wt. % to 3 wt. %, based on the total solids content of the barrier coating composition, including any endpoints and subranges therebetween.

Exemplary fire retardants may include, for example, halogenated materials, inorganic materials, nitrogen-based materials, antimony trioxide (e.g., FireGuard® ATO), intumescent materials, phosphorous materials, and the like (e.g., Tris(2-chloroethyl) phosphate, available from Sigma Aldrich). If present, the flame retardant may be included in the barrier coating composition in any amount to achieve an LOI (limiting oxygen index) of greater than 24%, according to EN ISO 4589-2. LOI is the minimum amount of oxygen in a nitrogen-oxygen mixture (in vol %) required to sustain flaming combustion of a material, with a higher percentage indicating a less flammable material. In any of the exemplary embodiments, the flame retardant is included in an amount to achieve an LOI according to EN ISO 4589-2 of at least 30%, at least 35%, at least 40%, at least 45%, or at least 50% and above. Such an amount may comprise from 0 wt. % to 10 wt. %, including from 0.1 wt. % to 8 wt. %, from 0.2 wt. % to 6 wt. %, from 0.3 wt. % to 5.5 wt. %, from 0.4 wt. % to 0.5 wt. %, from 0.8 wt. % to 3 wt. %, or from 1 wt. % to 2.5 wt. %, based on the total solids content of the barrier coating composition, including any endpoints and subranges therebetween.

Exemplary defoamers may include, for example, silicone-based defoamers (including silicone emulsions, polysiloxane, and the like), paraffin-based defoamers, diols, oils, etc. (e.g., Foamstar® ST2410, which is a defoamer based on block copolymer, Foamstar® ED 2522 NC, which is an ultra-low SVOC silicone emulsion defoamer, Foamstar® ST 2210 NC, which is a specially modified alcohol and polysiloxane adduct (Old name: Dehydran® 1620), available from BASF; BYK-035 9, which is a VOC-free mixture of paraffin based mineral oils and hydrophobic components, containing silicone, available from BYK; Surfadol® DF-75, 100% active nonionic defoaming agent based on acetylenic diols, Surfadol® 560 (silicone-containing defoamer), and Surfadol® 532 (acetylenic diol molecular defoamer), available from ACME Tech), and the like. If present, the defoamer may be included in the barrier coating composition in an amount from 0 wt. % to 10 wt. %, including from 0.01 wt. % to 8 wt. %, from 0.05 wt. % to 6 wt. %, from 0.06 wt. % to 5 wt. %, from 0.08 wt. % to 3 wt. %, from 0.1 wt. % to 2 wt. %, from 0.15 wt. % to 1 wt. %, or from 0.18 wt. % to 0.5 wt. %, based on the total solids content of the barrier coating composition, including any endpoints and subranges therebetween.

As mentioned above, the barrier coating composition may include an anti-blocker. Anti-blockers work to block surface adhesion between layers of a film and may optionally also have matting properties. The anti-blocker microscopically protrudes from a film's surface, creating asperities (i.e. “little bumps”), which help to minimize the film-to-film surface contact, increasing the distance between the two layers, thereby minimizing blocking. Exemplary anti-blockers include, for example, silica-based materials and amorphous silica (such an amorphous micronized silica, Gasil® 23F, available from PQ Corporation), flux-calcined diatomaceous earth (e.g., Dicalite WB-6), and large particle wax emulsions (e.g., Liquilube™ 405, available from Lubrizol), modified polypropylene wax (e.g., Lanco™ 1390 F, available from Lubrizofl), and hydrophilically modified, micronized polyolefin wax (e.g., Lanco™ PEW 1555 N, available from Lubrizol). The anti-blocker may be included in the barrier coating composition in an amount between 0 and 20 wt. %, based on the weight of the total solids content of the barrier coating composition, including between 0.01 wt. % and 15 wt. %, between 0.05 wt. % and 12 wt. %, between 0.1 wt. % and 10 wt. %, between 0.2 wt. % and 8 wt. %, between 0.5 wt. % and 6 wt. %, between 0.75 wt. % and 4 wt. %, and between 0.9 wt. % and 2 wt. %, including all subranges and endpoints therebetween.

Other additives are contemplated and possible. The amounts of any such additives can vary depending on the particular embodiment and, in general, can be (collectively or individually) from 0 wt. % to 30 wt. %, including from 0.01 wt. % to 25 wt. %, from 0.02 wt. % to 22 wt. %, from 0.05 wt. % to 20 wt. %, from 0.1 wt. % to 18 wt. %, from 0.5 wt. % to 15 wt. %, from 1 wt. % to 12 wt. %, from 1.5 wt. % to 10 wt. %, from 2 wt. % to 8 wt. %, from 2.5 wt. % to 6 wt. %, or from 3 wt. % to 5 wt. %, based on the total solids content of the barrier coating composition, including any endpoints and subranges therebetween.

Table 1 provides exemplary barrier coating compositions. It should be appreciated that any compositional range from Exemplary Range A may be combined with one or more of the compositional ranges from Exemplary Range B and/or Exemplary Range C and vice versa. Additionally, any of the compositional ranges in Exemplary Range A, Exemplary Range B, and Exemplary Range C may be combined with one or more of the compositional ranges disclosed in the paragraphs above. The compositional ranges below are intended to encompass and include any and all endpoints and subranges within the disclosed range.

TABLE 1

| | Exemplary Range A | Exemplary Range B | Exemplary Range C |
|---|---|---|---|
| | (in wt. % solids of | (in wt. % solids of | (in wt. % solids of |
| | total barrier coating | total barrier coating | total barrier coating |
| | composition) | composition) | composition) |
| Barrier Polymer | 40-99.9 wt. % | 70-99 wt. % | 70-96 wt. % |
| Rheology | 0-20 wt. % | 0.01-15 wt. % | 0.08-12 wt. % |
| Modifier | | | |
| Wetting Agent | 0-15 wt. % | 0-7 wt. % | 0.01-7 wt. % |
| pH adjuster | 0-15 wt. % | 0-5 wt. % | 0.25-5 wt. % |
| Defoamer | 0-5 wt. % | 0-2 wt. % | 0.01-2 wt. % |
| Antiblock Agent | 0-5 wt. % | 0-2 wt. % | 0.01-2 wt. % |
| UV Stabilizer | 0-12 wt. % | 0.05-5 wt. % | 0.5-5 wt. % |
| Flame Retardant | 0-5 wt. % | 0-2 wt. % | 0.1-2 wt. % |

The barrier polymer, along with any additives, can be dispersed in water and/or solvent and blended to form the barrier coating composition. As described above, the barrier coating composition is applied to at least one major surface of the insulation product and is dried to form a barrier coating on the surface. In some exemplary embodiments, the barrier coating is applied directly to a surface of the insulation product, without the use of adhesives, primers, or other layers between the barrier coating and the surface of the insulation product. Thus, in any of the embodiments disclosed herein, the insulation product is free of any polyamide primer coating that is applied to the insulation product prior to the barrier coating composition.

The barrier coating composition has a particular crystallinity, based on the crystallinity of the polymer used in the composition, although this crystallinity is impacted by the various additives included in the composition, such as wetting agents, rheology modifiers, and the like. Accordingly, a particular balance must be struck between achieving a coating composition with desirable viscosity and surface tension properties, while also ensuing the coating maintains sufficient crystallinity to provide a barrier functionality to keep the blowing agent from diffusing out of the foam product.

Although not intended to be bound by theory, it is believed that the precise balance struck between coating's overall crystallinity and its rheology and surface tension properties enables the application of the coating in a relatively low coat weight. Particularly, the barrier coating composition is applied at a coat weight of less than 250 g/m², including coat weights of no greater than 225 g/m², no greater than 200 g/m², no greater than 175 g/m², no greater than 150 g/m², no greater than 125 g/m², no greater than 100 g/m², no greater than 85 g/m², no greater than 60 g/m², no greater than 45 g/m², and no greater than 30 g/m². In an of the exemplary embodiments, the barrier coating composition may be applied to one or more surfaces of the polymer foam board in a coat weight between 3 g/m² and 225 g/m², including between 5 g/m² and 200 g/m², between 10 g/m² and 185 g/m², between 15 g/m² and 150 g/m², between 18 g/m² and 130 g/m², between 20 g/m² and 115 g/m², between 25 g/m² and 100 g/m², between 30 g/m² and 90 g/m², between 35 g/m² and 85 g/m², and between 40 g/m² and 80 g/m², including all endpoints and subranges therebetween.

Optionally, multiple coatings may be applied on one or more surface of the polymer insulation product. Such additional coatings may be added, for example, to enhance the properties of the barrier coating or to protect the barrier coating. In embodiments, the one or more additional coatings can impart hydrophobicity or water resistance to the coated insulation product. It should be appreciated that the at least one additional coating can be formed by applying a coating composition to the surface and allowing the coating composition to dry, thereby forming the at least one additional coating. The coating composition can be, for example, a dispersion (e.g., aqueous or solvent-based), liquid, or the like.

As described above, the one or more additional coatings may be applied on top of the barrier coating, such that the barrier coating is positioned between the one or more additional coatings and the polymer insulation product. In other embodiments, the one or more additional coatings may be applied between the barrier coating and the surface of the insulation product. The one or more additional coatings are not particularly limited and can be the same as or different from the barrier coating. In embodiments, the barrier coating is a first layer of a coating and the at least one additional coating is a second layer of the same coating. In embodiments, the barrier coating comprises a first polymer comprising polyvinylidene dichloride (PVDC), polyvinyl alcohol, polyvinylidene fluoride (PVDF), polyvinyl chloride (PVC), ethylene vinyl alcohol, polyurethane, styrene butadiene (SBR), and combinations or copolymers thereof and the at least one additional coating comprises a different polymer comprising polyvinylidene dichloride (PVDC), polyvinyl alcohol, polyvinylidene fluoride (PVDF), polyvinyl chloride (PVC), ethylene vinyl alcohol, polyurethane, styrene butadiene (SBR), and combinations or copolymers thereof. In embodiments, the at least one additional coating comprises one or more polyurethanes, epoxies, acrylics, or combinations thereof.

In such embodiments an additional coating layer is applied over the barrier coated insulation product, the additional coating preferably has a surface tension that is particularly tailored to the surface energy of the barrier coated insulation product. Accordingly, the one or more additional coatings are particularly formulated to possess a surface tension no greater than 20 mN/m above the surface energy of the barrier coated insulation product, including no greater than 15 mN/m, no greater than 10 mN/m, no greater than 8 mN/m, no greater than 5 mN/m, no greater than 2.5 mN/m, and no greater that 1 mN/m above the surface energy of the barrier coated insulation product. Similarly, if a coating layer is applied between the foam product and the barrier coating composition, the surface tension of barrier coating composition would need to be particularly formulated so as to be no greater than 20 mN/m, no greater than 15 mN/m, or no greater than 10 mN/m above the surface energy of the coated foam product.

Alternatively or additionally to the coating layer described above, the barrier coating composition may be injected into the extruder, such as through a port, and incorporated directly into the foamable composition.

In any of the exemplary embodiments disclosed herein, the foamable composition may comprise any material capable of being foamed (“matrix material”), such as a foamable polymer (referred to herein as the “matrix polymer”), cellular glass, and the like. The matrix polymer may be thermoplastic or thermoset. The particular polymer composition may be selected to provide sufficient mechanical strength and/or to the process utilized to form final foamed polymer products. In addition, the matrix polymer is preferably chemically stable, that is, generally non-reactive, within the expected temperature range during formation and subsequent use in a polymer foam.

As used herein, the term “polymer” is generic to the terms “homopolymer,” “copolymer,” “terpolymer,” and combinations of homopolymers, copolymers, and/or terpolymers. Non-limiting examples of suitable foamable polymers for use as the matrix polymer herein include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

In some exemplary embodiments, the foamable matrix polymer is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers or blends thereof with a non-alkenyl aromatic polymer.

Examples of alkenyl aromatic polymers include, but are not limited to, those alkenyl aromatic polymers derived from alkenyl aromatic compounds such as styrene, alpha-methylstyrene, ethylstyrene, vinyl benzene, vinyl toluene, chlorostyrene, and bromostyrene. In at least one embodiment, the alkenyl aromatic polymer is polystyrene.

In some embodiments, minor amounts of monoethylenically unsaturated monomers such as C₂ to C₆ alkyl acids and esters, ionomeric derivatives, and C₂ to C₆ dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In some embodiments, the matrix polymer may be formed substantially of (e.g., greater than 95 percent), and in certain exemplary embodiments, formed entirely of polystyrene. The matrix polymer may be present in the foamable polymer composition in an amount from about 60% to about 99% by weight, in an amount from about 60% to about 96% by weight, in an amount from about 70% to about 95% by weight, or in an amount from about 85% to about 94% by weight. In embodiments, the matrix polymer may be present in an amount from about 90% to about 99% by weight. As used herein, the terms “% by weight” and “wt. %” are used interchangeably and are meant to indicate a percentage based on 100% of the total weight of the dry components.

In any of the exemplary embodiments, the barrier coating composition described herein may be incorporated into the foamable composition. For example, instead of applying the barrier coating composition as a coating on at least one surface of the insulation product, (or in addition to) the barrier coating composition can be injected into the screw extruder 100. In embodiments in which the polymer of the barrier coating composition is a resin, the polymer may be introduced into the feed hopper 108 in pellet form. It should be appreciated that, when injected into the extruder, certain properties of the barrier coating composition may differ from those of a barrier coating composition intended for coating on a surface of the polymer insulation product, including, but not limited to, the viscosity of the coating composition and the solids loading of the barrier coating composition.

As indicated above, the foam insulation product is formed from a composition that contains a blowing agent composition. According to one aspect of the present invention, the blowing agent composition comprises one or more of: CO₂, fluorinated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, and fluoroiodocarbons, alkyl esters, such as methyl formate, ethanol, water, hydrocarbons, or mixtures thereof. In other exemplary embodiments, the blowing agent comprises one or more of CO₂, ethanol, HFOs, HCFOs, HFCs, and mixtures thereof.

In any of the exemplary embodiments, the blowing agent composition may comprise a material having a low global warming potential (“GWP”), such as a fluorinated alkene, including, for example, hydrofluoroolefins (HFOs) and hydrochlorofluoroolefins (HCFOs). The hydrofluoroolefin blowing agent in the blowing agent composition of the present invention may include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); 1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluoro-1-butene; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336mzz); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-1-butene; 3,3-difluoro-1-butene; 3,4,4-trifluoro-1-butene; 2,3,3-trifluoro-1-butene; 1,1,3,3-tetrafluoro-1-butene; 1,4,4,4-tetrafluoro-1-butene; 3,3,4,4-tetrafluoro-1-butene; 4,4-difluoro-1-butene; 1,1,1-trifluoro-2-butene; 2,4,4,4-tetrafluoro-1-butene; 1,1,1,2-tetrafluoro-2 butene; 1,1,4,4,4-pentafluoro-1-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. It should be appreciated that any of the above molecules may be present as the cis isomer, trans isomer, or a blend thereof. In some exemplary embodiments, the blowing agent or co-blowing agents include HFO-1234ze and/or HFO-1336mzz.

In any of the exemplary embodiments, the fluorinated alkene blowing agent may include, for example, 1,1,1,4,4,4-hexafluoro-2-butene (HFO-1336mzz) (including cis (HFO-1336mzz-Z) and/or trans (HFO-1336mzz-E) isomers thereof); and (cis and/or trans)-1,3,3,3-tetrafluoropropene (HFO-1234ze). HFO-1336mzz-Z has a GWP of 2 and an ozone depletion potential (ODP) of zero. HFO-1336mzz-Z is commercially available under the tradename Opteon™ 1100. Similarly, HFO-1234ze has a GWP of less than 1 and an ODP of zero. In some exemplary embodiments, the low GWP fluorinated alkene has a GWP of less than 50, such as less than 30, less than 25, less than 15, less than 10, less than 5, less than 2.5, or less than 1. In any of the exemplary embodiments, the blowing agent may comprise HFO-1336mzz-Z and is substantially free of additional fluorinated alkenes. In other embodiments, the blowing agent may comprise a blend of (cis and/or trans) HFO-1336mzz and (cis and/or trans) HFO-1234ze.

When present, the fluorinated alkene(s) may be present in the blowing agent composition in at least 0.5 wt. %, including at least 1 wt. %, at least 2 wt. %, at least 3 wt. %, 5 wt. %, at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %, based on the weight of the blowing agent composition. In any of the exemplary embodiments, the fluorinated alkene is present in the blowing agent composition in an amount no greater than 98%, including amounts no greater than 95 wt. %, no greater than 90 wt. %, no greater than 85 wt. %, no greater than 80 wt. %, no greater than 75 wt. %, no greater than 70 wt. %, no greater than 65 wt. %, no greater than 60 wt. %, no greater than 55 wt. %, no greater than 52 wt. %, no greater than 50 wt. %, no greater than 47 wt. %, no greater than 45 wt. %, no greater than 42 wt. %, no greater than 40 wt. %, no greater than 37 wt. %, no greater than 35 wt. %, no greater than 32 wt. %, no greater than 30 wt. %, and no greater than 25 wt. %. In any of the exemplary embodiments, the fluorinated alkene(s) may be present in the blowing agent composition in an amount between 3 wt. % and 98 wt. %, including, for example, between 5 wt. % and 85 wt. %, between 15 wt. % and 75 wt. %, between 20 wt. % and 65 wt. %, between 25 wt. % and 60 wt. %, between 28 wt. % and 57 wt. %, between 30 wt. % and 55 wt. %, and between 35 wt. % and 52 wt. %, including all endpoints and subranges therebetween.

The amount of fluorinated alkene may alternatively be characterized by the amount present in the foamable polymer composition. Thus, when characterized in this way, the fluorinated alkene may be present in the foamable polymer composition in at least 0.1 wt. %, including at least 0.2 wt. %, at least 0.5 wt. %, at least 0.7 wt. %, at least 1.0 wt. %, at least 1.2 wt. %, at least 1.5 wt. %, at least 2 wt. %, at least 2.3 wt. %, at least 2.5 wt. %, at least 2.7 wt. %, at least 3.0 wt. %, at least 3.5 wt. %, at least 3.7 wt. %, at least 3.9 wt. %, and at least 4 wt. %. In any of the exemplary embodiments, the fluorinated alkene may be present in the foamable polymer composition in an amount no greater than 10 wt. %, including amounts no greater than 8 wt. %, no greater than 6 wt. %, no greater than 4.5 wt. %, no greater than 4 wt. %, no greater than 3.8 wt. %, no greater than 3.5 wt. %, no greater than 3 wt. %, no greater than 2.5 wt. %, no greater than 2.3 wt. %, no greater than 2 wt. %, no greater than 1.8 wt. %, no greater than 1.5 wt. %, no greater than 1.2 wt. %, no greater than 1 wt. %, no greater than 0.8 wt. %, and no greater than 0.6 wt. %.

In any of the aspects disclosed herein, the fluorinated alkene may be present in the foamable polymer composition in an amount between 0.5 wt. % and 7 wt. %, including, for example, between 0.8 wt. % and 6 wt. %, between 1 wt. % and 4.8 wt. %, between 1.2 wt. % and 4.5 wt. %, between 1.4 wt. % and 4.2 wt. %, between 1.8 wt. % and 4 wt. %, and between 2 wt. % and 3.8 wt. % including all endpoints and subranges therebetween.

According to any aspect of the disclosure, the fluorinated alkene may be present as a blend of two or more fluorinated alkenes. For instance, the fluorinated alkene may comprise a blend of a first fluorinated alkene and a second fluorinated alkene, with the weight ratio of first alkene to second alkene being from 1:99 to 99:1, including, for example, from 5:95 to 95:5, from 8:92 to 92:8, from 10:90 to 90:10, from 15:85 to 85:15, from 20:80 to 80:20, from 25:75 to 75:25, from 35:65 to 65:35, from 40:60 to 60:40, and from 45:55 to 55:45. According to any aspect, the first fluorinate alkene may be present in the blowing agent composition in an amount between 5 and 60 wt. %, including, for example, between 8 and 55 wt. %, between 10 and 50 wt. %, between 12 and 45 wt. %, between 15 wt. % and 40 wt. %, between 18 wt. % and 38 wt. %, and between 20 wt. % and 35 wt. %, including all endpoints and subranges therebetween. In these or other aspects, the second fluorinated alkene may be present in the blowing agent composition in an amount between 0.5 and 50 wt. %, including, for example, between 1 and 45 wt. %, between 3 and 40 wt. %, between 5 and 35 wt. %, between 5.5 wt. % and 30 wt. %, between 8 wt. % and 28 wt. %, and between 10 wt. % and 25 wt. %, including all endpoints and subranges therebetween. The first fluorinated alkene can comprise a C4-C6 fluorinated alkene having a molecular weight of at least 150 g/mol. An exemplary first fluorinated alkene includes 1,1,1,4,4,4-hexafluoro-2-butene (HFO-1336mzz) (including cis (HFO-1336mzz-Z) and/or trans (HFO-1336mzz-E) isomers thereof). The second fluorinated alkene can comprise a C2-C3 fluorinated alkene having a molecular weight less than 150 g/mol. An exemplary second fluorinated alkene includes 1,3,3,3-tetrafluoropropene (HFO-1234ze) (including cis (HFO-1234ze-Z) and/or trans (HFO-1234ze-E) isomers thereof).

The amount of fluorinated alkene may alternatively be characterized by the molar amount per 100 grams of the of the matrix polymer. Thus, when characterized in this way the total amount of fluorinated alkene(s) may be present in the foamable polymer composition in an amount less than 0.1 moles per 100 grams of the of the matrix polymer, including no greater than 0.05 moles, no greater than 0.03 moles, no greater than 0.02 moles, no greater than 0.018 moles, and no greater than 0.01 moles. In any of the exemplary embodiments, the total amount of fluorinated alkene(s) may be present in foamable polymer composition in an amount between 0 moles and less than 0.1 moles per 100 grams of the of the matrix polymer, including between 0.0001 moles and 0.025 moles, between 0.0005 moles and 0.022 moles, between 0.001 moles and 0.02 moles, and between 0.005 moles and 0.019 moles per 100 grams of the of the matrix polymer, including all endpoints and subranges therebetween. It has been surprisingly discovered that by including a ratio of first alkene to second alkene of at least 50:50, a reduced amount of total fluoroalkene moles in the matrix polymer may be achieved, while still producing an insulation foam with sufficient mechanical and thermal performance. In such aspects, the total amount of fluoroalkene moles is less than 0.027 moles, or less than 0.025 moles, or less than 0.02 moles per 100 grams of the matrix polymer.

It has surprisingly been discovered that the total concentration of fluorinated alkene can be substantially reduced, and in some embodiments, eliminated from the blowing agent composition, due to the use of the subject barrier coating composition, without negatively impacting the thermal properties of the polymer foam (i.e., still achieving at least an 180-day R/in value of at least 4.8 and preferably at least 5). In such embodiments, the blowing agent composition may be free of fluorinated alkenes or may be included in less than 4 wt. %, less than 3.5 wt. %, less than 3 wt. %, less than 2.5 wt. %, or less than 2 wt. %, based on the total weight of the polymer insulation product.

The blowing agent composition may optionally include one or more co-blowing agents, such as, for example, hydrocarbons, hydrofluorocarbons (“HFC”), hydrochlorofluorocarbons (“HCFO”), carbon dioxide, methyl formate, methylal, and water. When present, the co-blowing agent(s) may be included in the blowing agent composition in at least 0.1 wt. %, including at least 0.3 wt. %, at least 0.5 wt. %, at least 0.75 wt. %, at least 1 wt. %, at least 2 wt. %, at least 3 wt. %, 5 wt. %, at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %. In any of the exemplary embodiments, the co-blowing agent is present in the blowing agent composition in an amount no greater than 98%, including amounts no greater than 95 wt. %, no greater than 90 wt. %, no greater than 85 wt. %, no greater than 80 wt. %, no greater than 75 wt. %, no greater than 70 wt. %, no greater than 65 wt. %, no greater than 60 wt. %, no greater than 55 wt. %, no greater than 52 wt. %, no greater than 50 wt. %, no greater than 47 wt. %, no greater than 45 wt. %, no greater than 42 wt. %, no greater than 40 wt. %, no greater than 37 wt. %, no greater than 35 wt. %, no greater than 32 wt. %, no greater than 30 wt. %, and no greater than 25 wt. %. In any of the exemplary embodiments, the co-blowing agent(s) may be present in the blowing agent composition in an amount between 5 wt. % and 98 wt. %, including, for example, between 10 wt. % and 85 wt. %, between 15 wt. % and 80 wt. %, between 20 wt. % and 75 wt. %, between 25 wt. % and 70 wt. %, between 30 wt. % and 68 wt. %, and between 35 wt. % and 65 wt. %, including all endpoints and subranges therebetween.

As mentioned above, the blowing agent may comprise one or more hydrocarbons.

Suitable hydrocarbons include, but are not limited to, C1 to C6 aliphatic hydrocarbons, such as methane, ethane, propane, n-butane, isobuatane, and neopentane, and C1 to C3 aliphatic alcohols, such as methanol, ethanol, n-propanol, and isopropanol.

The blowing agent may optionally comprise one or more hydrofluorocarbons. The specific hydrofluorocarbon utilized is not particularly limited. A non-exhaustive list of examples of suitable blowing HFC blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), 1,3,3,3-pentafluoropropane (HFO-1234ze), pentafluoro-ethane (HFC-125), fluoroethane (HFC-161), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof. In some exemplary embodiments, the blowing agent comprises HFC-152a. Exemplary HFC blowing agents or blends thereof are commercially available under the tradename FORMACEL™, including but not limited to FORMACEL™ B and FORMACEL™ Z6.

Exemplary blowing agent compositions comprise 15 wt. % to 60 wt. % of a fluorinated alkene selected from HFO-1336mzz, HFO-1234ze, or mixtures thereof, 40 wt. % to 85 wt. % of HFC-152a, and optionally a balance of carbon dioxide, based on the total weight of the blowing agent composition, including all endpoints and subranges therebetween. Stated differently, the exemplary blowing agent compositions can comprise 2 wt. % to 5 wt. % HFO-1336mzz and/or HFO-1234ze, 2.5 wt. % to 6 wt. % HFC-152a, and optionally a balance of carbon dioxide, based on the total weight of the foamable polymer composition, including compositions comprising 2.5 wt. % to 4.8 wt. % HFO-1336mzz and/or HFO-1234ze, 3 wt. % to 5.5 wt. % HFC-152a, and optionally carbon dioxide, based on the total weight of the foamable polymer composition. Further exemplary blowing agent compositions can comprise 3 wt. % to 4.5 wt. % HFO-1234ze and/or HFO-1336mzz, 2.8 wt. % to 5 wt. % HFC-152a, and optionally carbon dioxide, based on the total weight of the foamable polymer composition, including compositions comprising 3.2 wt. % to 4.2 wt. % HFO-1234ze and/or HFO-1336mzz, 3.0 wt. % to 4.8 wt. % HFC-152a, and optionally carbon dioxide, based on the total weight of the foamable polymer composition.

The co-blowing agent may also comprise one or more hydrochlorofluoroolefins (HCFO), such as HCFO-1233; 1-chloro-1,2,2,2-tetrafluoroethane (HCFC-124); 1,1-dichloro-1-fluoroethane (HCFC-141b); 1, 1, 1, 2-tetrafluoroethane (HFC-134a); 1,1,2,2-tetrafluoroethane (HFC-134); 1-chloro-1,1-difluoroethane (HCFC-142b); 1,1,1,3,3-pentafluorobutane (HFC-365mfc); 1,1,1,2,3,3,3-heptafluoropropane (HFC-227ea); tnchlorofluoromethane (CFC-11); dichlorodifluoromethane (CFC-12); and dichlorofluoromethane (HCFC-22).

The term “HCFO-1233” is used herein to refer to all trifluoromonochloropropenes. Among the trifluoromonochloropropenes are included both cis- and trans-1,1,1-trifluo-3, chlororopropene (HCFO-1233zd or 1233zd). The term “HCFO-1233zd” or “1233zd” is used herein generically to refer to 1,1,1-trifluo-3-chloro-propene, independent of whether it is the cis- or trans-form. The terms “cis HCFO-1233zd” and “trans HCFO-1233zd” are used herein to describe the cis- and trans-forms or trans-isomer of 1,1,1-trifluo, 3-chlororopropene, respectively.

In some aspects, the blowing agent composition may include two or more non-fluorinated blowing agents, such as a hydrocarbon and carbon dioxide. In other exemplary embodiments, the blowing agent formulation may be free of carbon dioxide and/or water. In various exemplary embodiments, the blowing agent composition is free of a hydrofluorocarbon and/or a hydrofluoroolefin.

As mentioned above, aspects of the present inventive concepts are directed to the discovery that the total concentration of fluorinated alkene can be substantially reduced, and in some embodiments, eliminated from the blowing agent composition, due to the use of the subject barrier coating composition, without negatively impacting the thermal properties of the polymer foam (i.e., still achieving at least an 180-day R/in value of at least 4.8 and preferably at least 5). In such embodiments, the blowing agent composition may comprise or consist of CO₂. The CO₂ may be present in an amount of 25 wt. % or more, 50 wt. % or more, 55 wt. % or more, 60 wt. % or more, 65 wt. % or more, 70 wt. % or more, 75 wt. % or more, 80 wt. % or more, 85 wt. % or more, 90 wt. % or more, 92 wt. % or more, 95 wt. % or more, 96 wt. % or more, or even 98 wt. % or more based on a total weight of the blowing agent composition.

In addition to CO₂, the blowing agent composition may optionally comprise co-blowing agents, such as methyl formate, methylal, ethanol, isobutane, propylene carbonate, etc., in at least 0.5 wt. %, including at least 1 wt. %, at least 2 wt. %, at least 3 wt. %, 5 wt. %, at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %, based on the weight of the blowing agent composition. In any of the exemplary embodiments, the co-blowing agent(s) may be present in the blowing agent composition in an amount no greater than 50%, including amounts no greater than 45 wt. %, no greater than 40 wt. %, no greater than 38 wt. %, no greater than 35 wt. %, no greater than 30 wt. %, no greater than 25 wt. %, no greater than 20 wt. %, no greater than 15 wt. %, and no greater than 10 wt. %. In any of the exemplary embodiments, the co-blowing agents(s) may be present in the blowing agent composition in an amount between 1 wt. % and 50 wt. %, including, for example, between 3 wt. % and 45 wt. %, between 5 wt. % and 40 wt. %, between 8 wt. % and 35 wt. %, between 10 wt. % and 30 wt. %, and between 12 wt. % and 27 wt. %, including all endpoints and subranges therebetween.

Stated differently, the co-blowing agents may be included in the foamable polymer composition in amounts up to 5 wt. %, based on the total weight of the foamable polymer composition, including in amounts between 0.1 wt. % and 4.5 wt. %, 0.25 wt. % and 4 wt. %, 0.5 wt. % and 3.5 wt. %, between 0.75 and 3.25 wt. %, 1 and 3 wt. %, 1.25 and 2.5 wt. %, and 1.3 and 2 wt. %, based on the total weight of the foamable polymer composition.

Exemplary blowing agent compositions comprise 0 to 80 wt. % of a fluorinated alkene and 20 wt. % to 100 wt. % of carbon dioxide, based on the total weight of the blowing agent composition, including all endpoints and subranges therebetween. For example, the blowing agent composition may comprise 0 to 60 wt. % of a fluorinated alkene selected from HFO-1336mzz, HFO-1234ze, or mixtures thereof, and 40 wt. % to 100 wt. % of carbon dioxide, based on the total weight of the blowing agent composition, including all endpoints and subranges therebetween. Stated differently, the exemplary blowing agent compositions may comprise 0 to 4 wt. % of a fluorinated alkene and 2.5 wt. % to 7 wt. % carbon dioxide, based on the total weight of the foamable polymer composition, including compositions comprising no greater than 3 wt. % of a fluorinated alkene and at least 2 wt. % carbon dioxide, based on the total weight of the foamable polymer composition. Further exemplary blowing agent compositions may comprise 0.2 to 2 wt. % of a fluorinated alkene and 2.5 wt. % to 6 wt. % carbon dioxide, based on the total weight of the foamable polymer composition.

Exemplary blowing agent compositions may comprise 1 to 5 wt. % carbon dioxide and 0.2 to 3.5 wt. % of one or more co-blowing agents, such as methyl formate, methylal, ethanol, isobutane, propylene carbonate, etc., based on the total weight of the foamable polymer composition, including compositions comprising 1.8 to 4 wt. % carbon dioxide and 0.7 to 2.5 wt. % of one or more co-blowing agent, and compositions comprising 2 to 3.6 wt. % carbon dioxide and 0.9 to 2 wt. % of one or more co-blowing agent, based on the total weight of the foamable polymer composition. Further exemplary blowing agent compositions may comprise 2.5 to 3.5 wt. % of a carbon dioxide and 1 to 1.7 wt. % methyl formate (or other suitable solubilizer), based on the total weight of the foamable polymer composition. In these or other embodiments, the blowing agent compositions may include a limited amount of fluorinated alkene, such as no greater than 3 wt. %, based on the total weight of the foamable polymer composition, including amounts between 0 and 2.8 wt. %, between 0.2 and 2.6 wt. %, between 0.5 and 2.4 wt. %, between 0.8 and 2.1 wt. %, between 1 and 1.8 wt. %, between 1.2 and 1.6 wt. %, including all endpoints and subranges therebetween.

Further exemplary blowing agent compositions may include 50 wt. % to 100 wt. % CO₂ and 0 wt. % to 50 wt. % of one or more hydrocarbons, such as isobutane, 60 wt. % to 99 wt. % CO₂ and 1 wt. % to 40 wt. % of one or more hydrocarbons, 70 wt. % to 98 wt. % CO₂ and 2 wt. % to 30 wt. % of one or more hydrocarbons, and 80 wt. % to 96 wt. % CO₂ and 3 wt. % to 12 wt. % of one or more hydrocarbons, including all endpoints and subranges therebetween.

When characterizing the blowing agent by its weight percent present in the foamable polymer composition, the blowing agent composition is present in at least 2 wt. %, including at least 2.8 wt. %, at least 3 wt. %, at least 3.3 wt. %, at least 3.5 wt. %, at least 3.8 wt. %, at least 4 wt. %, at least 4.3 wt. %, at least 4.5 wt. %, at least 4.7 wt. %, and at least 5 wt. %. In any of the exemplary embodiments, the blowing agent may be present in the foamable polymer composition in an amount no greater than 10 wt. %, including amounts no greater than 9 wt. %, no greater than 8.5 wt. %, no greater than 8 wt. %, no greater than 7.8 wt. %, no greater than 7.5 wt. %, no greater than 7.2 wt. %, no greater than 7 wt. %, no greater than 6.9 wt. %, no greater than 6.8 wt. %, no greater than 6.65 wt. %, no greater than 6.5 wt. %, no greater than 6 wt. %, no greater than 5.8 wt. %, no greater than 5.5 wt. %, no greater than 5 wt. %, no greater than 4.9 wt. %, and no greater than 4.8 wt. %. In any of the aspects contemplated herein, the blowing agent composition may be present in the foamable composition in an amount between 2 wt. % and 7 wt. %, including between 2.5 wt. % and 6.8 wt. %, between 2.7 wt. % and 6.5 wt. %, between 2.9 wt. % and 6 wt. %, and between 3 wt. % and 5.5 wt. %.

The amount of blowing agent may alternatively be characterized by the molar amount of blowing agent composition per 100 grams of the of the polymer composition. Thus, when characterized in this way the blowing agent composition may be present in the foamable polymer composition in an amount between 0.001 moles and less than 0.1 moles per 100 grams of the of the polymer, including between 0.01 moles and 0.09 moles, between 0.03 moles and 0.08 moles, and between 0.04 moles and 0.075 moles per 100 grams of the of the polymer composition.

In embodiments in which the barrier coating composition is injected into the screw feeder or otherwise incorporated into the foamable polymer mixture, it should be appreciated that water included in the barrier coating composition add to the amount and, thus, the blowing power, of the blowing agent.

It has been surprisingly discovered that the use of the barrier coating composition as described herein can enable the reduction or elimination of fluorinated blowing agents to yield a polymer insulation product with sufficient insulation value, as compared to an otherwise identical foam product without the barrier coating. For instance, conventionally, to achieve a polymer insulation product with an R-value of at least 5, a certain minimum level of fluorinated blowing agent was necessary. Although more accessible, cost effective, and environmentally friendly, CO₂ could not comprise the majority of a blowing agent composition, as it would diffuse from the foam almost upon production, and thereby have unacceptably low insulation values. However, in some exemplary embodiments, the amount of fluorinated blowing agent can be reduced and replaced with CO₂, without negatively impacting thermal performance. Accordingly, although the total amount of blowing agent used in the polymer insulation product may not change, the amount of fluorinated blowing agent may be reduced by at least 15 wt. %, at least 20 wt. %, at least 25 wt. %, at least 30 wt. %, at least 35 wt. %, at least 40 wt. %, at least 50 wt. %, at least 55 wt. %, or at least 50 wt. %, and replaced with CO₂, and still produce a polymer insulation product with an insulation value of at least R-5.

Optional additives such as infrared attenuating agents, processing aids, nucleating agents, plasticizing agents, pigments, elastomers, extrusion aids, antioxidants, fillers, antistatic agents, biocides, termite-ocide, surfactants, colorants, oils, waxes, flame retardant synergists, and/or UV absorbers/stabilizers may be incorporated into the foamable composition. These optional additives may be included in amounts necessary to obtain desired characteristics of the foamable gel or resultant extruded foam products. The additives may be added to the foamable composition, or they may be incorporated in the foamable composition before, during, or after the polymerization process used to make the polymer.

As mentioned above, the foamable composition may further contain at least one infrared attenuating agent (IAA) to increase the R-value of the resulting foam product. Non-limiting examples of suitable infrared attenuating agents for use in the present composition include graphite, including nanographite, carbon black, powdered amorphous carbon, asphalt, granulated asphalt, milled glass, talc, fiber glass strands, mica, black iron oxide, metal flakes (for example, aluminum flakes), carbon nanotube, nanographene platelets, carbon nanofiber, activated carbon, titanium dioxide, and combinations thereof. In some exemplary embodiments, the infrared attenuating agent is present in the foamable composition in an amount from 0 to 5.0% by weight of the total composition. In other embodiments, the infrared attenuating agent may be present in an amount from 0.05 to 3.0% by weight, from 0.08 to 2.0% by weight, or from 0.1 to 1.0% by weight. In some exemplary embodiments, the infrared attenuating agent is present in the composition in an amount less than or equal to 0.5% by weight.

In at least one exemplary embodiment, the infrared attenuating agent is nanographite. The nanographite can be multilayered by furnace high temperature expansion from acid-treated natural graphite or microwave heating expansion from moisture saturated natural graphite. In addition, the nanographite may be a multi-layered nanographite which has at least one dimension with a thickness less than 100 nm. In some exemplary embodiments, the graphite may be mechanically treated such as by air jet milling to pulverize the nanographite particles. The pulverization of the particles ensures that the nanographite flake and other dimensions of the particles are less than 150 microns.

The nanographite may or may not be chemically or surface modified and may be compounded in a polyethylene methyl acrylate copolymer (EMA), which is used both as a medium and a carrier for the nanographite. Other possible carriers for the nanographite include polymer carriers such as, but not limited to, polymethyl methacrylate (PMMA), polystyrene, polyvinyl alcohol (PVOH), and polyvinyl acetate (PVA). In exemplary embodiments, the nanographite is substantially evenly distributed throughout the foam. As used herein, the phrase “substantially evenly distributed” is meant to indicate that the substance (for example, nanographite) is evenly distributed or nearly evenly distributed within the foam.

Although the infrared attenuating agent increases the R-value for foams that include HFO and/or HFC blowing agents, the addition of infrared attenuating agents also tends to decrease the cell size of the cells in the foam, which results in undesirable final foamed products. In particular, small cell sizes tend to increase board bulk density, increase product cost, and reduce the process window during the extrusion process. However, it has been surprisingly discovered that the amount of infrared attenuating agent included in the foamable composition may be reduced, or eliminated when barrier coating compositions are applied to or within the polymer foam. Accordingly, in any of the exemplary embodiments, the foamable polymer composition and resulting foam product include less than 0.25 wt. % of an infrared attenuating agent, such as graphite, including less than 0.2 wt. %, less than 0.15 wt. %, less than 0.10 wt. %, and less than 0.05 wt. %. In any of the exemplary embodiments, the foamable composition and resulting foam product are free of an infrared attenuating agent, such as graphite. It should be appreciated that such embodiments, a nucleator (e.g., inorganic substances such as talc, clay, and/or calcium carbonate) may be included in the foamable composition to control the size of the foam cells. In some aspects, the infrared attenuating agent may be included in the barrier coating composition, in addition to or instead of in the foamable polymer.

The foamable composition may further contain a fire retarding agent in an amount up to 5.0% or more by weight. For example, fire retardant chemicals may be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymer flame retardant such as brominated polymer flame retardant, phosphoric compounds, and combinations thereof.

Once the blowing agent composition, barrier coating composition, and optional additional additives have been introduced into the foamable polymer composition, the resulting mixture is subjected to some additional blending sufficient to distribute each of the additives generally uniformly throughout the polymer composition to obtain an extrusion or expandable composition.

The foamable polymer composition disclosed herein may produce a rigid, foamed polymer insulation product via any manufacturing process, such as extrusion, expansion, reaction mixture, spray, bubbling, and the like. Such foam products have a cellular structure with cells defined by cell membranes and struts. Struts are formed at the intersection of the cell membranes, with the cell membranes covering interconnecting cellular windows between the struts.

In some exemplary embodiments, the polymer insulation product has an average density of less than 10 pcf (pound per cubic foot), including less than 5 pcf, less than 3 pcf, and less than 2.5 pcf when produced at atmospheric conditions. However, the density may be less when the polymer insulation product is produced under vacuum. In any of the exemplary embodiments, the polymer insulation product has a density of 2.40 pcf or less, or 2.25 pcf or less, or 2.20 pcf or less, or 2.00 pcf or less, or 1.60 pcf or less. In any of the exemplary embodiments, the polymer insulation product has an average density between 1.40 pcf and 2.40 pcf, including between 1.40 pcf and 2.25 pcf, between 1.40 pcf and 2.00 pcf, between 1.40 pcf and 1.60 pcf, between 1.45 pcf and 1.55 pcf, between 2.10 pcf and 2.30 pcf, and between 2.20 pcf and 2.28 pcf.

It is to be appreciated that the phrase “substantially closed cell” is meant to indicate that all or nearly all of the cells in the cellular structure of the insulation product are closed. For example, “substantially closed cell” may be meant to indicate that not more than 30.0% of the cells are open cells, and particularly, not more than 10.0%, or more than 5.0% are open cells, or otherwise “non-closed” cells. The closed cell structure helps to increase the R-value of a formed, foamed insulation product. It is to be appreciated, however, that it is within the purview of various embodiments to produce an open cell structure, although such an open cell structure is not an exemplary embodiment.

The average cell size of the polymer insulation product may range from 0.005 mm (5 microns) to 0.6 mm (600 microns) and, in some exemplary embodiments, from 0.05 mm (50 microns) to 0.4 mm (400 microns), or from 0.1 mm (100 microns) to 0.2 mm (200 microns).

Once coated with the subject barrier coating composition, the coated insulation product disclosed herein demonstrates insulation values (R-values) of greater than 4.5 per inch and maintains an R-value of at least 4.5 after 180 days. In any of the exemplary embodiments, the coated insulation product may have an R-value per inch after 180 days of at least 5, or at least 5.3 or at least 5.5, or at least 5.7, or at least 6. In any of the exemplary embodiments, the R-value per inch may be at least 5, or at least 5.5, or at least 6, or at least 6.5, or at least 7, after 7 days, 25 days, 60 days, or after 180 days.

The foamable composition additionally may produce foam products that have a high compressive strength, which defines the capacity of a foam material to withstand axially directed pushing forces. In some exemplary embodiments, the foam has a compressive strength within the range of between about 6 and 120 psi. In some exemplary embodiments, the foam product has a compressive strength between 10 and 110 psi, including between 20 and 100 psi, between 30 and 80 psi, and between 35 and 60 psi. In various exemplary embodiments, the foam product has a compressive strength between 40 and 50 psi.

The insulation products contemplated herein may be used to form a variety of products, such as a rigid insulation board, insulation foam, packaging product, building insulation (e.g., residential, commercial, industrial building(s)), underground insulation (for example, highway, airport runway, railway, and underground utility insulation), and the like. The insulation products may further be utilized in multi-material sheathing systems. The sheathing system may include one or more panels capable of being attached to a frame of a structure to form a sheath that envelopes at least a portion of a structure as a wall portion (e.g., vertical surface) and/or as a roofing portion. The panels may comprise any combination of one or more structural portion(s), one or more barrier layer(s), and one or more insulation panels. The structural portion may comprise a single-layer material or a multiple-layer construction. For example, the structural portion of the panel may comprise a variety of different materials, such as fiberglass, wood, wood composite materials (i.e., oriented strand board (“OSB”)), magnesium oxide board, a plywood layer, a foil poly structural layer, a high-density polyethylene (HDPE) layer, a polymer-based composite, or any other structural layer. In some embodiments, the structural portion is a structural barrier layer comprising fiberglass, polycarbonate, polypropylene, high-density polyethylene, or wood composite. The one or more insulation layer(s) may comprise or consist of the subject insulation foam product disclosed herein. In any of the exemplary embodiments, the sheathing system may comprise an insulation product adhered to a structural portion, or a barrier layer adhered to a first surface of an insulation product and a structural portion adhered to a second surface of the insulation product.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the generic disclosure. Additionally, following examples are meant to better illustrate the present invention, but do in no way limit the general inventive concepts of the present invention.

### Example 1

Extruded polystyrene foam samples were prepared using a co-rotating twin screw extrusion foam manufacturing line. Polystyrene was melted in the extruder and mixed with an injected blowing agent composition to form a homogeneous foamable composition. The foamable composition for each sample (excluding the blowing agent) included polystyrene, flame retardant masterbatch, and graphite (or infrared attenuating agent) masterbatch. A blowing agent blend was included at a generally constant total amount across all samples. The blowing agent blends are provided below in Table 2 (based on the total weight of the foamable composition) and generally included a fluorinated alkene and/or CO₂, whereby the concentration of fluorinated alkene was gradually reduced and replaced with CO₂. A co-blowing agent, methyl formate, was included with the blowing agent blend. The foamable compositions were then extruded to produce 1-inch XPS foam samples, each having a density of about 2.1-2.2 lb/ft³.

TABLE 2

| | | | Methyl | | Flame |
|---|---|---|---|---|---|
| Sample | HFO | CO₂ | formate | IAA | retardant |
| No | (wt. %) | (wt. %) | (wt. %) | (wt. %) | (wt. %) |
| 1 | 0.00 | 3.31 | 1.50 | 0.60 | 1.00 |
| 2 | 0.20 | 3.21 | 1.50 | 0.60 | 1.00 |
| 3 | 0.40 | 3.11 | 1.50 | 0.60 | 1.00 |
| 4 | 0.60 | 3.01 | 1.50 | 0.60 | 1.00 |
| 5 | 0.80 | 2.91 | 1.50 | 0.60 | 1.00 |
| 6 | 1.00 | 2.81 | 1.50 | 0.60 | 1.00 |
| 7 | 1.25 | 2.69 | 1.50 | 0.60 | 1.00 |
| 8 | 1.50 | 2.56 | 1.50 | 0.60 | 1.00 |

Upon formation, eight samples (Examples 1-8) the XPS foam samples were coated on all surfaces with a partially crystalline PVDC-based barrier coating composition at the coat weights detailed below in Table 3. Eight additional samples of corresponding compositions were left uncoated as Comparative Examples 1-8.

Properties of each of the samples are provided in Table 3 below. For each of the Examples, the thermal conductivity was measured at approximately 7 days, 20 days, 30 days, 60 days, 120 days and 180-day time intervals. The 180 days k-values (Btu·in/h·ft²·° F.) are reported in Table 3. R-values at 180 days were calculated from the reciprocal of the 180 days k values, and are also reported in Table 3, along with compressive strength and compressive modulus (measured in accordance with ASTM C578 and CAN UL S701), and open cell content (%).

TABLE 3

| | Final | 180-days | 180- | Compressive | Compressive | |
|---|---|---|---|---|---|---|
| Sample | Coat Weight | k-values | days | Strength | Modulus | Open Cell |
| No. | (g) | (Btu · in/h · ft² · ° F.) | R/in | (psi) | (psi) | (%) |
| Comp. | — | 0.2279 | 4.39 | 44.5 | 1626 | 2.57 |
| Ex. 1 | | | | | | |
| Comp. | — | 0.2277 | 4.39 | 48.0 | 1745 | 2.93 |
| Ex. 2 | | | | | | |
| Comp. | — | 0.2273 | 4.40 | 47.9 | 1933 | 1.04 |
| Ex. 3 | | | | | | |
| Comp. | — | 0.2263 | 4.42 | 46.6 | 1987 | 0.7 |
| Ex. 4 | | | | | | |
| Comp. | — | 0.2243 | 4.46 | 45.9 | 1953 | 2.41 |
| Ex. 5 | | | | | | |
| Comp. | — | 0.2224 | 4.50 | 44.6 | 1869 | 1.22 |
| Ex. 6 | | | | | | |
| Comp. | — | 0.2203 | 4.54 | 45.7 | 1923 | 2.48 |
| Ex. 7 | | | | | | |
| Comp. | — | 0.2184 | 4.58 | 44.5 | 1839 | 1.17 |
| Ex. 8 | | | | | | |
| Ex. 1 | 5.13 | 0.2244 | 4.46 | 44.5 | 1626 | 2.57 |
| | (~23.66 g/m²) | | | | | |
| Ex. 2 | 4.99 | 0.2147 | 4.66 | 48.0 | 1745 | 2.93 |
| | (~23.66 g/m²) | | | | | |
| Ex. 3 | 5.11 | 0.2192 | 4.56 | 47.9 | 1933 | 1.04 |
| | (~23.02 g/m²) | | | | | |
| Ex. 4 | 5.13 | 0.2256 | 4.43 | 46.6 | 1987 | 0.7 |
| | (~23.66 g/m²) | | | | | |
| Ex. 5 | 4.28 | 0.2192 | 4.56 | 45.9 | 1953 | 2.41 |
| | (~19.74 g/m²) | | | | | |
| Ex. 6 | 3.84 | 0.2212 | 4.52 | 44.6 | 1869 | 1.22 |
| | (~17.71 g/m²) | | | | | |
| Ex. 7 | 4.05 | 0.2179 | 4.59 | 45.7 | 1923 | 2.48 |
| | (~18.68 g/m²) | | | | | |
| Ex. 8 | 4.80 | 0.2127 | 4.70 | 44.5 | 1839 | 1.17 |
| | (~22.14 g/m²) | | | | | |

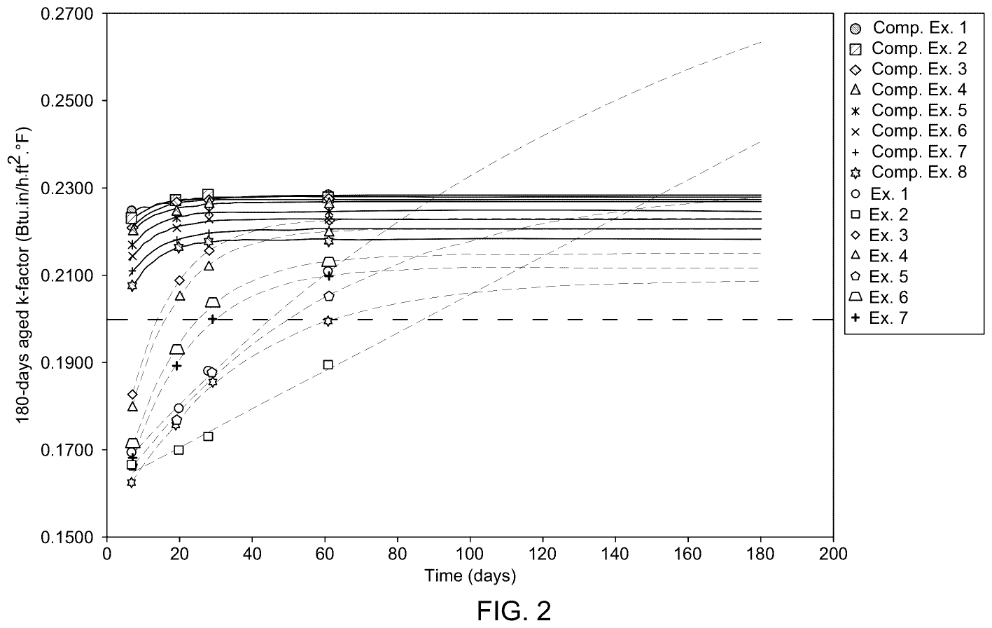

As is conventionally known, an R-value of 5 is achieved at a thermal conductivity of 0.20 Btu·in/h·ft²·° F. or below. As shown in the graph of FIG. 2, replacing the HFO with increasing amounts of CO₂ in uncoated XPS foam samples increases the k-values across the board and does not achieve an R-value of 5 or greater even after only 7 days. However, each of Examples 1-8 achieve an R-5 insulation value after 7 days and Examples 2 and 8 maintained the R-5 insulation value even after 60 days. As both Example 2 and 8 included an unconventionally high concentration of CO₂, the results confirm that use of the subject barrier coating composition in coat weights below 30 g/m² facilitate the production of R-5 XPS insulation products with a majority of the blowing agent comprising CO₂, and minimal, if any HFO.

The graph of FIG. 2 further illustrates the improvement in k-value over time that the barrier coating provides XPS foam samples. Namely, the coating is effective at low coat weights (such as below 30 g/m²) to significantly improve k-value for XPS foams and particularly make it possible to produce an XPS foam product with an R-value of at least 5, while using a blowing agent comprising a majority CO₂, rather than a fluorinated alkene.

### Example 2

Extruded polystyrene foam samples were prepared using a co-rotating twin screw extrusion foam line. Polystyrene was melted in the extruder and mixed with an injected blowing agent composition to form a homogeneous foamable composition. The foamable composition for Comparative Samples B-E and Samples A-D (excluding the blowing agent) included polystyrene and flame retardant masterbatch. The foamable composition for Comparative Samples A and F and Samples F and G (excluding the blowing agent) included 100 wt. % polystyrene, flame retardant masterbatch, and graphite masterbatch. A blowing agent blend was included at a constant total amount across all samples. The blowing agent blend included a 30-40 wt. % of a fluorinated alkene and 60-70 wt. % of a fluorinated alkane, with the remainder of the blowing agent blend being CO₂. As the amount of fluorinated alkene was reduced, the amount of CO₂ was increased to maintain a constant level of total blowing agent. The foamable compositions were then extruded to produce 1-inch XPS foam samples, each having a density of about 1.83 pcf.

For coated samples, a barrier coating composition comprising PVOH (an aqueous dispersion of polyvinyl alcohol) was applied. Properties of each of the samples are provided in Table 4 below.

TABLE 4

| | Fluorinated | | | Final | 180-days | |
|---|---|---|---|---|---|---|
| Sample | Alkene | | Coating | Coat Weight | k-value | 180-days |
| No. | (wt. %) | IAA | Composition | (g) | (Btu · in/h · ft² · ° F.) | R/in |
| Comp. Ex. A | 3.0 | Yes | None | — | 0.2009 | 4.98 |
| Comp. Ex. B | 3.0 | No | None | — | 0.2111 | 4.79 |
| Comp. Ex. C | 2.5 | No | None | — | 0.2175 | 4.67 |
| Comp. Ex. D | 2.0 | No | None | — | 0.2210 | 4.56 |
| Comp. Ex. E | 1.5 | No | None | — | 0.2262 | 4.45 |
| Ex. A | 3.0 | No | Yes | 15.50 | 0.1833 | 5.52 |
| | | | | (71.50 g/m²) | | |
| Ex. B | 2.5 | No | Yes | 14.49 | 0.1827 | 5.55 |
| | | | | (66.84 g/m²) | | |
| Ex. C | 2.0 | No | Yes | 14.24 | 0.1911 | 5.28 |
| | | | | (65.69 g/m²) | | |
| Ex. D | 1.5 | No | Yes | 13.90 | 0.2019 | 4.95 |
| | | | | (64.12 g/m²) | | |
| Comp. Ex. F | 1.5 | Yes | No | — | 0.2163 | 4.67 |
| Ex. F | 3.0 | Yes | Yes | 11.79 | 0.1755 | 5.78 |
| | | | | (54.39 g/m²) | | |
| Ex. G | 1.5 | Yes | Yes | 13.74 | 0.1868 | 5.45 |
| | | | | (63.38 g/m²) | | |

As shown in Table 4, reducing the concentration of fluorinated alkene from 3 wt. % to 1.5 wt. % in uncoated foam samples increases the 180-day k-value from 0.2009 to 0.2262 Btu*in/h ft²·° F., and decreases the sample's R-value to below 4.5. However, when the foam samples were coated with the barrier coating composition, the samples were able to achieve an insulation value of R-5 even as the concentration of fluorinated alkene dropped below 2 wt. %.

Additionally, the removal of graphite from the foam composition led to an increased k-factor (Comparative Examples B-E as compared to Comparative Example A), with an increased amount of fluorinated alkene blowing agent having less of an k-factor impact. However, the use of the inventive barrier coating on the foam (Examples A-D) reduced the k-factor to an amount below the control (Comparative Sample A).

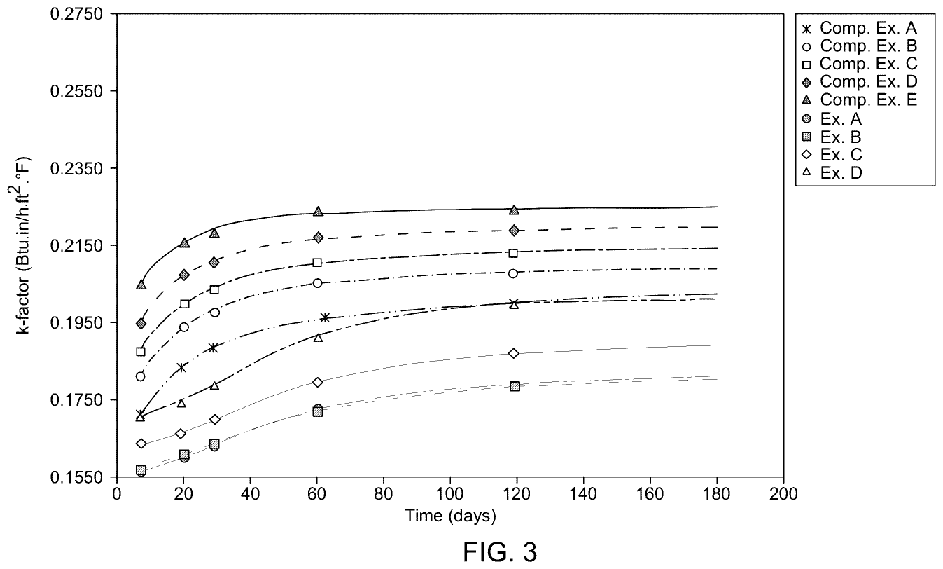

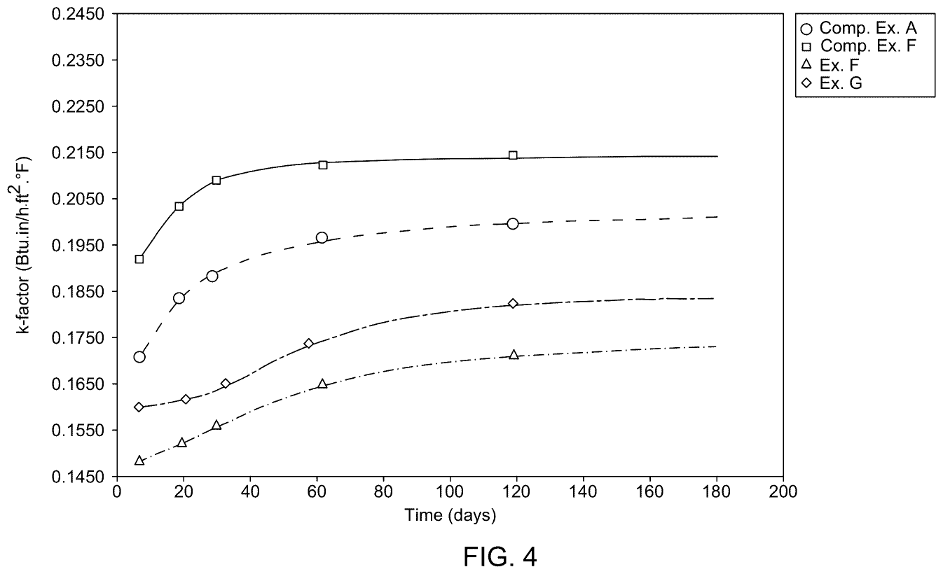

Notably, in FIGS. 3 and 4, respectively, a combination of a PVOH-based barrier coating with increased levels of fluorinated alkene blowing agent yielded the greatest improvement in insulation properties. However, the graphs of FIGS. 3 and 4 demonstrate that less blowing agent can be used to achieve the same or improved insulation properties.

### Example 3

A barrier coating composition comprising DIOFAN® A050 (a PVDC dispersion containing about 58 wt. % solids commercially available from Solvay) was applied with a brush to various surfaces of 1-inch XPS foam samples at various coat weights, as set forth in Table 5 below. The XPS foam was formed using a blowing agent composition comprising a blend of HFO-1336mzz-Z and HFC-152a.

TABLE 5

| | | Final | 180 days | 180 |
|---|---|---|---|---|
| Sample | | Coat Weight | k-value | days |
| No | Coating | (g) | (Btu · in/h · ft² · ° F.) | R/in |
| Comp. | No Coating | — | 0.2017 | 4.96 |
| Ex G | | | | |
| Ex. H | PVDC-based | 2.32 | 0.1969 | 5.08 |
| | | (~10.7 g/m²) | | |
| Ex. I | PVDC-based | 4.71 | 0.1790 | 5.59 |
| | | ((~21.73 g.m²) | | |
| Ex. J | PVDC-based | 7.12 | 0.1538 | 6.50 |
| | | (~32.85 g/m²) | | |

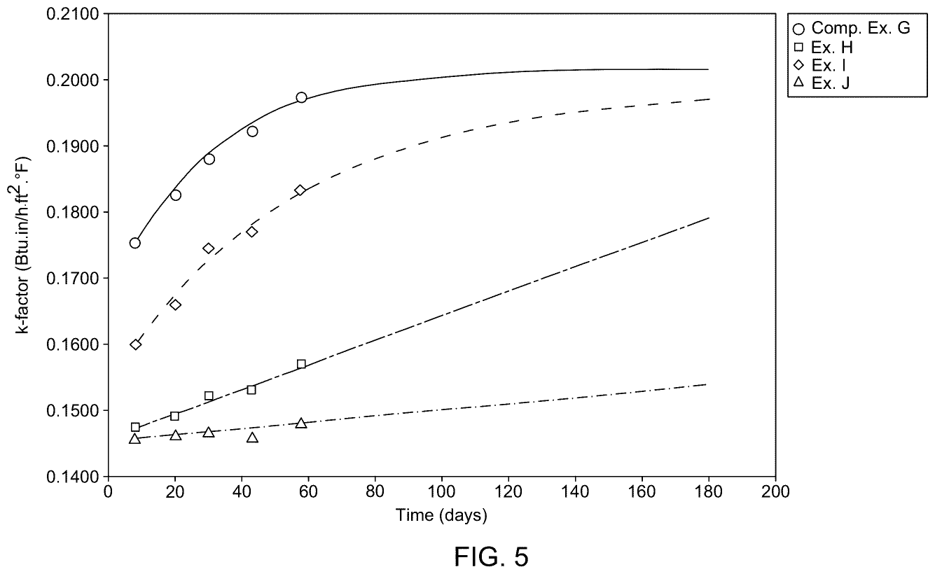

As shown in Table 5 and the graph of FIG. 5, the effectiveness of the barrier coating at significantly slowing the diffusion rates of the blowing agents increased with increased coating weight, as indicated by the improved R-values and reduced 180 day k-values, as compared to the control (Comparative Ex. G).

### Example 4

Extruded polystyrene foams including various blowing agent compositions were prepared and coated with the barrier coating composition in accordance with the present inventive concepts to evaluate the effects of the barrier coating on the thermal conductivity properties of the foams. Each of the foamable compositions are provided below in Table 6.

TABLE 6

| | | | | Flame | |
|---|---|---|---|---|---|
| Sample | CO₂ | Isobutane | IAA | Retardant | Density |
| No | (wt. %) | (wt. %) | (wt. %) | (wt. %) | (lb/ft³) |
| Comp. Ex. H | 3.31 | 1.00 | 0.50 | 1.00 | 2.71 |
| Comp. Ex. I | 3.31 | 0.75 | 0.50 | 1.00 | 2.57 |
| Comp. Ex. J | 3.31 | 0.50 | 0.50 | 1.00 | 2.41 |
| Comp. Ex. K | 3.31 | 0.25 | 0.50 | 1.00 | 2.31 |
| Comp. Ex. L | 3.31 | 0.13 | 0.50 | 1.00 | 2.16 |
| Ex. K | 3.31 | 1.00 | 0.50 | 1.00 | 2.05 |
| Ex. L | 3.31 | 0.75 | 0.50 | 1.00 | 2.71 |
| Ex. M | 3.31 | 0.50 | 0.50 | 1.00 | 2.57 |
| Ex. N | 3.31 | 0.25 | 0.50 | 1.00 | 2.41 |
| Ex. O | 3.31 | 0.13 | 0.50 | 1.00 | 2.31 |
| Ex. P | 3.31 | 0.50 | 0.50 | 1.00 | 2.16 |
| Ex. Q | 3.31 | 0.50 | 0.50 | 1.00 | 2.05 |
| Ex. R | 3.31 | 0.50 | 0.50 | 1.00 | 1.94 |
| Ex. S | 3.31 | 0.50 | 0.50 | 1.00 | 1.83 |
| Ex. T | 3.31 | 0.50 | 0.50 | 1.00 | 1.72 |

To the foam products in Examples K-O, a barrier coating including DIOFAN® A050 was applied to all surfaces of the foam sample, including the edges, in various coat weights. Comparative Samples H-L were the control samples, and no barrier coating was applied. Example P was coated with a DIOFAN® A050-based coating on each major surface (e.g., top and bottom), but not the minor surfaces. Examples Q-S were coated on the top and bottom surfaces, along with one, two, and three minor surfaces, respectively. Example T was coated only the four minor surfaces.

For each Example, the thermal conductivity was measured at approximately 7-day, 20-day, 30-day, 60-day, 120-day, and 180-day time intervals. The thermal conductivity (k-values) (Btu·in/h·ft²·° F.) are reported in Table 7. R-values at 180 days were calculated from the reciprocal of the 180 days thermal conductivities and are also reported in Table 7.

TABLE 7

| | | | Final | 180 days | |
|---|---|---|---|---|---|
| Sample | | Coated | Coat Weight | k-value | 180-days |
| No | Coating | Surfaces | (g) | (Btu · in/h · ft² · ° F.) | R/in |
| Comp. Ex. H | No Coating | — | — | 0.2174 | 4.60 |
| Comp. Ex. I | No Coating | — | — | 0.2173 | 4.60 |
| Comp. Ex. J | No Coating | — | — | 0.2189 | 4.57 |
| Comp. Ex. K | No Coating | — | — | 0.2220 | 4.50 |
| Comp. Ex. L | No Coating | — | — | 0.2222 | 4.50 |
| Ex. K | PVDC-based | Top/Bottom/4 | 5.61 | 0.2142 | 4.67 |
| | | edges | (~25.88 g/m²) | | |
| Ex. L | PVDC-based | Top/Bottom/4 | 6.23 | 0.2124 | 4.71 |
| | | edges | (~28.74 g/m²) | | |
| Ex. M | PVDC-based | Top/Bottom/4 | 5.16 | 0.2125 | 4.71 |
| | | edges | (~23.80 g/m²) | | |
| Ex. N | PVDC-based | Top/Bottom/4 | 3.56 | 0.2211 | 4.52 |
| | | edges | (~16.42 g/m²) | | |
| Ex. O | PVDC-based | Top/Bottom/4 | 6.21 | 0.2216 | 4.51 |
| | | edges | (~28.65 g/m²) | | |
| Ex. P | PVDC-based | Top/Bottom | 4.01 | 0.2111 | 4.74 |
| | | | (~18.50 g/m²) | | |
| Ex. Q | PVDC-based | Top/Bottom/1 | 4.58 | 0.2127 | 4.70 |
| | | edge | (~21.13 g/m²) | | |
| Ex. R | PVDC-based | Top/Bottom/2 | 4.69 | 0.2139 | 4.68 |
| | | edges | (~21.64 g/m²) | | |
| Ex. S | PVDC-based | Top/Bottom/3 | 4.02 | 0.2183 | 4.58 |
| | | edges | (~18.54 g/m²) | | |
| Ex. T | PVDC-based | 4 edges only | 1.26 | 0.2189 | 4.57 |
| | | | (~5.95 g/m²) | | |

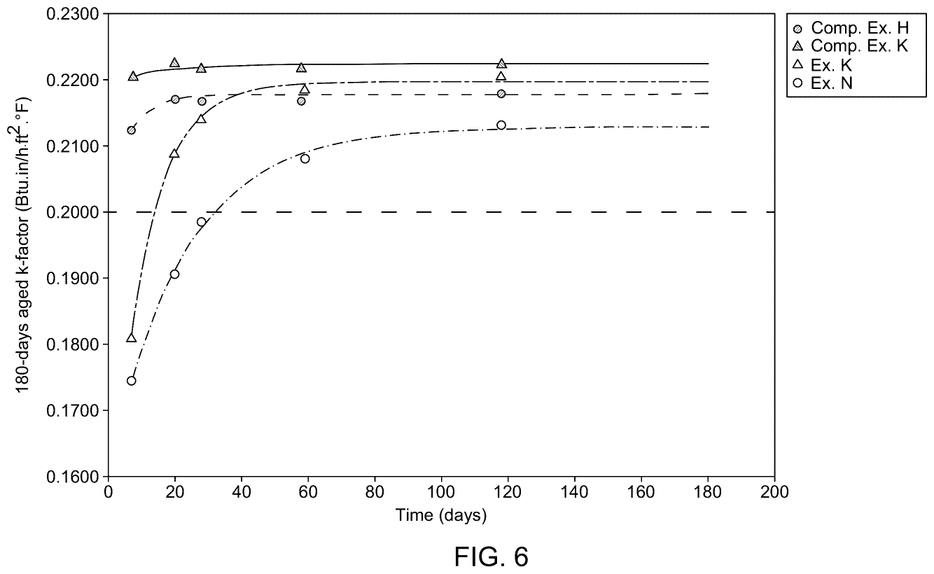

The graph of FIG. 6 plots the measured thermal conductivity (k-factor) (y-axis) as a function of time in days (x-axis) for samples including blowing agents comprising both 1 wt. % isobutane and 0.25 wt. % isobutane, both with and without the barrier coating (Comparative Examples H and K and Examples K and N). As can be seen in Table 7 and FIG. 6, the application of the DIOFAN® A050-based coating is effective to reduce the thermal conductivity of the polymer insulation product such that the polymer insulation product has an R-value of 5 or greater over a longer period of time, as compared to an otherwise identical but uncoated polymer insulation product. Particularly, for the samples tested in this example, an R-value of 5 is achieved at a thermal conductivity of 0.20 Btu·in/h·ft²·° F. or below. As shown in FIG. 6, not a single Comparative Example achieved an R-value of 5 at any time point. However, Example N achieved an R-value of 5 at about k₁₅ and Example K maintained an R-value of 5 at k₃₀, which is a significant improvement over the Comparative Examples and supports the conclusion that a polymer insulation layer formed with CO₂ (excluding any fluorinated alkenes) can achieve an R-5 insulation value, when manufactured with a barrier coating composition as disclosed herein.

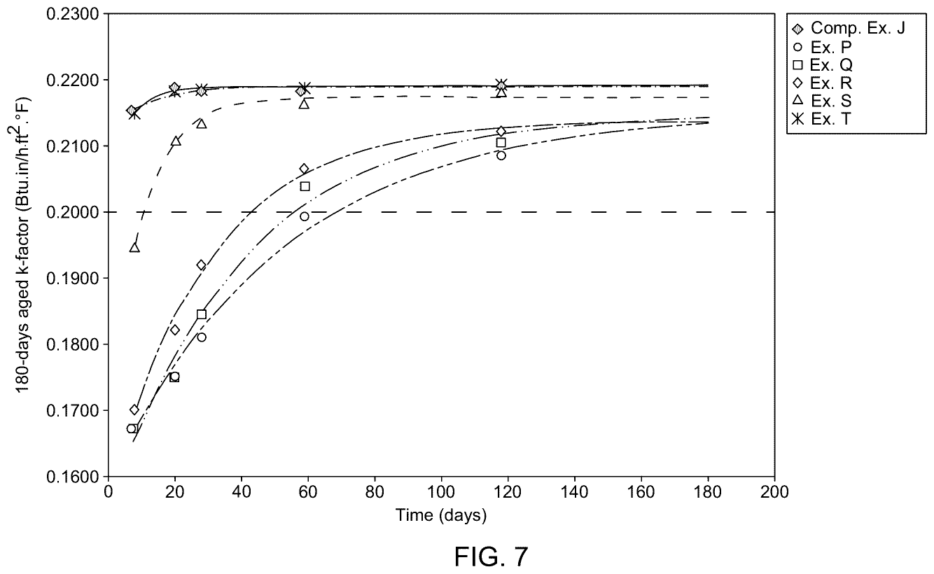

The graph of FIG. 7 plots the measured thermal conductivity (k-factor) (y-axis) as a function of time in days (x-axis) for samples including 0.50 wt. % isobutane and with various surfaces having the barrier coating thereon (Comparative Example J and Examples P-T). As shown in FIG. 7, application of the barrier coating to the major surfaces of the polymer insulation product has the biggest impact, while coating the only the edges has almost no impact (See, Example T).

### Example 5

A barrier coating composition comprising an aqueous dispersion of styrene butadiene rubber was brushed onto one or more surfaces of 1-inch samples of extruded polystyrene foam and dried to form a barrier coated polystyrene foam. The polystyrene foam was formed using a blowing agent composition comprising a blend of HFO-1336mzz-Z and HFC-152a. Locations of the application of the barrier coating composition are provided below in Table 8.

TABLE 8

| | | 180 days | |
|---|---|---|---|
| Sample | Coated | k-value | 180 days |
| No | Surfaces | (Btu · in/h · ft² · ° F.) | R/in |
| Comp. | No coating | 0.1976 | 5.06 |
| Ex. M | | | |
| Ex. U | Top/bottom/4 edges | 0.1954 | 5.12 |
| Ex. V | Top and bottom only | 0.1963 | 5.09 |
| Ex. W | Top/bottom/3 edges | 0.1956 | 5.11 |
| Ex. X | 4 edges only | 0.1981 | 5.05 |

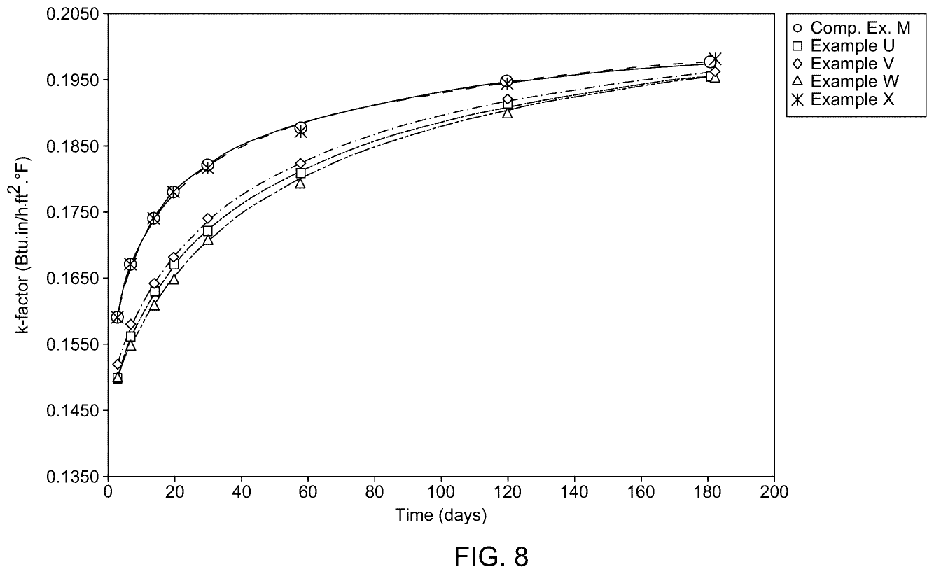

As illustrated in the graph of FIG. 8, each of samples that had at least the top and bottom coated (Examples U-W) with the barrier coating composition exhibited improved thermal properties (lower k-value and increased R-value) as compared to the control sample (Comp. Ex. M) and the sample with only the edges coated (Example X).

### Example 6

Extruded polystyrene foam samples were prepared using a co-rotating twin screw single extrusion foam manufacturing line. Polystyrene was melted in the extruder and mixed with an injected blowing agent composition to form a homogeneous foamable composition. The foamable composition (excluding the blowing agent) included polystyrene, flame retardant masterbatch, and graphite masterbatch, and is reported as the “solids” in Table 9 below. An aqueous dispersion of styrene butadiene rubber (50 wt. % solids in water) was injected directly into the extruder at various concentrations. The polystyrene foam was formed using a blowing agent composition comprising a blend of HFO-1336mzz-Z and HFC-152a in a constant amount across all samples. The foamable compositions were then extruded to produce 1-inch XPS foam samples. Each of the foamable compositions are provided below in Table 9.

TABLE 9

| Sample | Solids | SBR |
|---|---|---|
| No | (wt. %) | (wt. %) |
| Comp. Ex. N | 100 | 0.00 |
| Ex. Y | 99.95 | 0.05 |
| Ex. Z | 99.90 | 0.10 |
| Ex. AA | 99.85 | 0.15 |
| Ex.BB | 99.80 | 0.20 |
| Ex. CC | 99.75 | 0.25 |
| Ex. DD | 99.62 | 0.38 |
| Ex. EE | 99.50 | 0.50 |

Table 10, below, lists the properties of the resulting XPS foam samples.

TABLE 10

| | | | | Avg. | | | |
|---|---|---|---|---|---|---|---|
| | | 180 days | 180 | Cell | Open | Compressive | Compressive |
| Sample | Density | k-value | days | Sizes | Cells | Strength | Modulus |
| No | (lb/ft³) | (Btu · in/h · ft² · ° F.) | R/in | (mm) | (%) | (psi) | (psi) |
| Comp. Ex. N | 2.27 | 0.1997 | 5.01 | 0.18 | 1.5 | 42.6 | 1180 |
| Ex. Y | 2.24 | 0.1986 | 5.04 | 0.17 | 1.96 | 43.9 | 1187 |
| Ex. Z | 2.23 | 0.1991 | 5.02 | 0.17 | 0.44 | 44.7 | 1256 |
| Ex. AA | 2.17 | 0.1973 | 5.07 | 0.19 | 1.73 | 42.9 | 1269 |
| Ex. BB | 2.19 | 0.1983 | 5.04 | 0.17 | 1.19 | 44.3 | 1234 |
| Ex. CC | 2.19 | 0.1976 | 5.06 | 0.17 | 1.70 | 45.6 | 1352 |
| Ex. DD | 2.16 | 0.2011 | 4.97 | 0.17 | 0.36 | 47.3 | 1491 |
| Ex. EE | 2.30 | 0.2018 | 4.96 | 0.17 | 1.17 | 55.0 | 2015 |

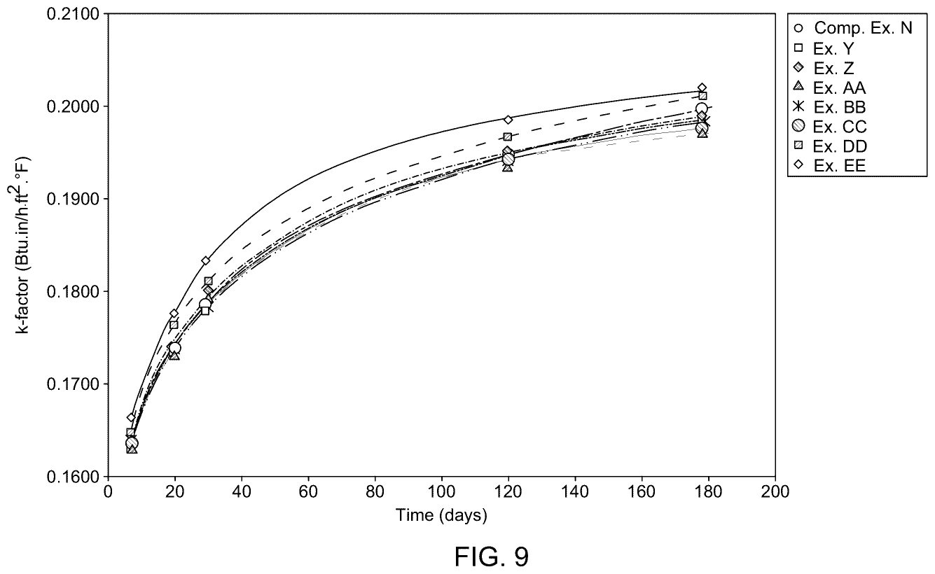

As shown in Table 10 and the graph of FIG. 9, XPS foam produced including SBR dispersion in amounts from 0.05 wt. % to 0.25 wt. % demonstrated improved insulation properties (e.g., a lower k-value) as compared to the control (Comp. Example N). Additionally, the data presented in Table 9 illustrates that the barrier coating composition can be injected during the foaming process without negatively impacting the foam properties. For example, the compressive strength and compressive modulus for each of the examples was increased as compared to the control sample (Comp. Example N).

### Example 7

Varying amounts of one of two barrier coatings (an aqueous dispersion of ethylene vinyl alcohol (EVOH) or an aqueous dispersion of polyvinyl alcohol (PVOH)) were applied with a brush to various surfaces of 1-inch XPS foam samples. Locations of the application of the barrier coating composition are provided below in Table 11.

TABLE 11

| | | | | 180-days | |
|---|---|---|---|---|---|
| Sample | Coated | Coating | Final | k-value | 180-days |
| No | Surfaces | Composition | Coat Weight(g) | (Btu · in/h · ft² · ° F.) | R/in |
| Comp. Ex. O | No coating | N/A | 0.00 | 0.2134 | 4.69 |
| Ex. FF | Top/bottom/4 edges | EVOH | 7.40 | 0.2077 | 4.81 |
| | | | (~34.14 g/m²) | | |
| Ex. GG | Top/4 edges | EVOH | 18.01 | 0.1955 | 5.12 |
| | | | (~83.08 g/m²) | | |
| Ex. HH | Top only | EVOH | 4.51 | 0.2087 | 4.79 |
| | | | (~20.81 g/m²) | | |
| Ex. II | Top/bottom/4 edges | EVOH | 17.30 | 0.1910 | 5.24 |
| | | | (~79.81 g/m²) | | |
| Ex. JJ | Top/bottom/4 edges | PVOH | 8.39 | 0.1860 | 5.38 |
| | | | (~38.70 g/m²) | | |
| Ex. KK | Top/4 edges | PVOH | 11.23 | 0.1787 | 5.60 |
| | | | (~51.81g/m²) | | |
| Ex. LL | Top only | PVOH | 7.98 | 0.1736 | 5.76 |
| | | | (~36.81 g/m²) | | |
| Ex. MM | Top/bottom/4 edges | PVOH | 8.00 | 0.1959 | 5.11 |
| | | | (~36.91 g/m²) | | |

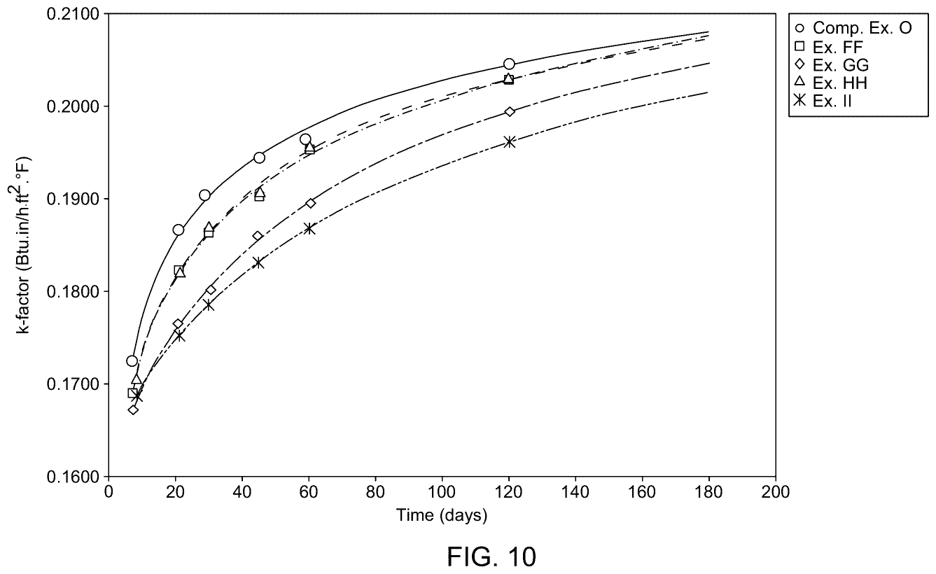

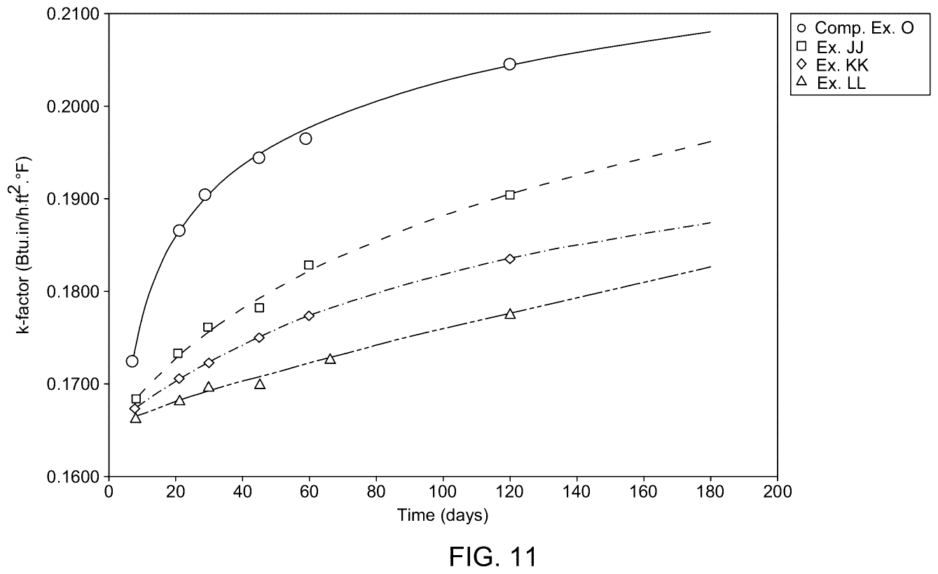

As shown in Table 11 and the graphs of FIGS. 10-11, respectively, both the EVOH and PVOH coatings were effective at significantly slowing the diffusion rates of the blowing agents, as indicated by the improved R-values and reduced 180 day k-values, as compared to the control (Comp. Example O). For Example LL, PVOH improved the R-value of the foam sample by about 23%, as compared to the control (Comp. Example O). Additionally, the results show that it is not necessarily true that more coating leads to better thermal conductivity. Rather, Example LL, having about 36.81 g/m² of coating applied to the sample demonstrates a better 180-day thermal conductivity value than Examples KK, JJ, and MM, each having a heavier application of PVOH-based barrier coating. Thus, a balance must be struck between coat weight and impact to the foam product's thermal conductivity to achieve optimal performance.

### Example 8

Various barrier coatings and barrier coating combinations were applied to 1-inch XPS foam samples, as set forth in Table 13 below. PUD 1 and PUD 2 are two different commercially available polyurethane dispersions. For Samples OO and PP, the PVOH coating system was applied to the foam surface first and allowed to dry and then the PUD 1 or PUD 2 were applied to the top of the PVOH coating.

TABLE 12

| | | 180 days | |
|---|---|---|---|
| Sample | | k-value | 180 days |
| No | Coating | (Btu · in/h · ft² · ° F.) | R/in |
| Comp. Ex. P | None | 0.2078 | 4.81 |
| Ex. NN | PVOH | 0.1901 | 5.26 |
| Comp. Ex. Q | PUD1 | 0.2084 | 4.80 |
| Comp. Ex. R | PUD2 | 0.2086 | 4.79 |
| Ex. OO | PVOH + PUD1 | 0.1759 | 5.69 |
| Ex. PP | PVOH + PUD2 | 0.1795 | 5.57 |

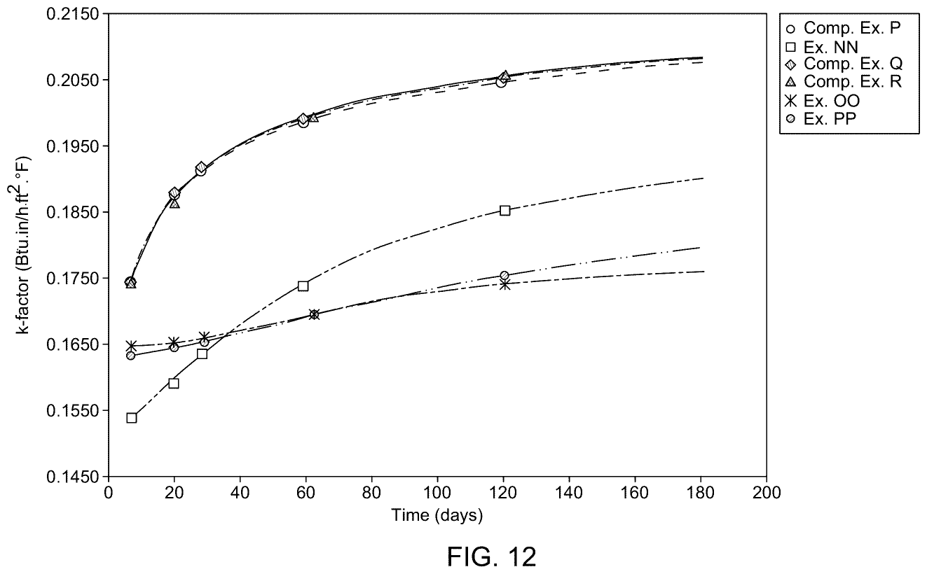

As shown in FIG. 12, the PUD 1 and PUD 2 applied coatings by themselves (Comp. Examples Q and R, respectively) did not provide any barrier properties to the foam. However, when applied to the surface of the applied PVOH coating (Samples OO and PP, respectively), they enhanced the barrier properties of the PVOH coating (Sample NN). Without being bound by theory, it is believed that the application of a PUD or hydrophobic coating to a PVOH or EVOH coating, which tend to be more hydrophilic and susceptible to moisture, may protect the hydrophilic coating and enhance the resistant properties of the hydrophilic coating.

### Example 9

Extruded polystyrene foams including various blowing agent compositions were prepared and coated with the barrier coating composition in accordance with the present inventive concepts to evaluate the effects of the barrier coating on the thermal conductivity properties of the foams. Each of the foamable compositions are provided below in Table 13.

TABLE 13

| | | Methyl | | Flame | |
|---|---|---|---|---|---|
| Sample | CO₂ | Formate | IAA | Retardant | Density |
| No | (wt. %) | (wt. %) | (wt. %) | (wt. %) | (lb/ft³) |
| Comp. Ex. S | 3.31 | 1.50 | 0.60 | 1.00 | 2.27 |
| Ex. QQ | 3.31 | 1.50 | 0.60 | 1.00 | 2.27 |
| Ex. RR | 3.31 | 1.50 | 0.60 | 1.00 | 2.27 |
| Ex.SS | 3.31 | 1.50 | 0.60 | 1.00 | 2.27 |

A barrier coating composition comprising DIOFAN® A050 (a PVDC dispersion containing about 58 wt. % solids commercially available from Solvay) was applied with a brush to various surfaces of 1-inch XPS foam samples at various coat weights, as set forth in Table 14 below.

TABLE 14

| | | Final | 180 days | 180 |
|---|---|---|---|---|
| Sample | | Coat Weight | k-value | days |
| No | Coating | (g) | (Btu · in/h · ft² · ° F.) | R/in |
| Comp. | No Coating | — | 0.2298 | 4.35 |
| Ex. S | | | | |
| Ex. QQ | PVDC-based | 6.22 | 0.2050 | 4.88 |
| | | (~28.69 g/m²) | | |
| Ex. RR | PVDC-based | 11.93 | 0.1970 | 5.20 |
| | | (~55.03 g/m²) | | |
| Ex. SS | PVDC-based | 21.03 | 0.1766 | 5.66 |
| | | (~95.21 g/m²) | | |

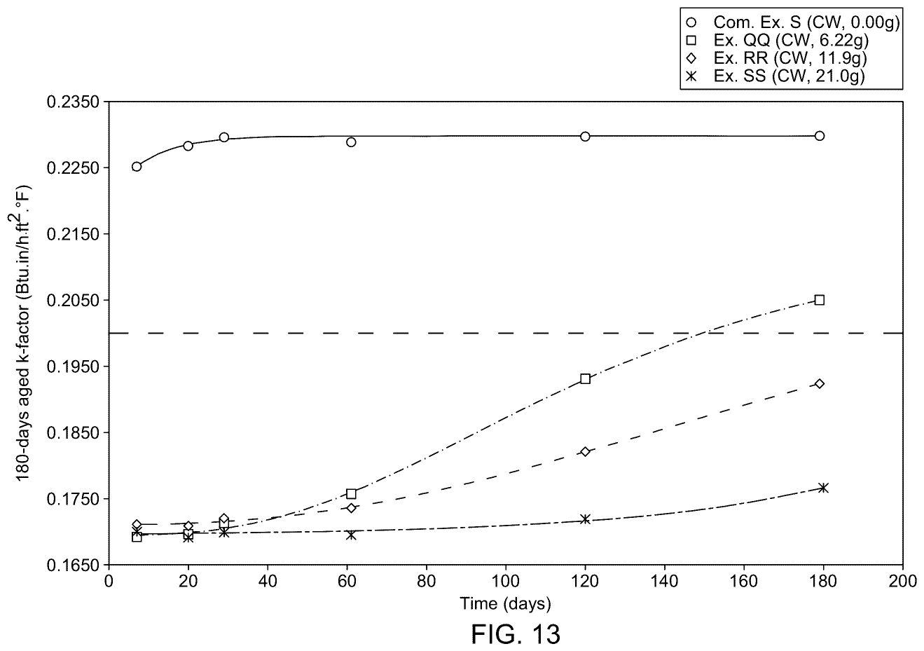

As shown in Table 14 and the graph of FIG. 13, the effectiveness of the barrier coating at significantly slowing the diffusion rates of the blowing agents increased with increased coating weight, as indicated by the improved R-values and reduced 180 day k-values, as compared to the control.

### Example 10

Extruded polystyrene foam samples were prepared using a co-rotating twin screw extrusion foam line. Polystyrene was melted in the extruder and mixed with an injected blowing agent composition to form a homogeneous foamable composition. Each foamable composition was the same, and included 100 wt. % polystyrene, flame retardant masterbatch, and graphite masterbatch. A blowing agent blend comprising a blend of a fluorinated alkene and a hydrofluorocarbon was included as a constant between all samples, in both concentration and composition.

The foamable compositions were extruded to produce 1-inch XPS foam samples, each having a density of about 2.2 pcf.

Comparative Sample 1 was left uncoated, while Samples 1 to 5 were coated with an exemplary barrier coating composition on at least one side using a hand sprayer, as outlined in Table 15, below. The barrier coating composition is provided below in Table 16.

TABLE 15

| | Foam Sample | Foam + Coat | Foam + Coat | Final Coat |
|---|---|---|---|---|
| Sample | Wt. | 1 Wt. | 2 Wt. | Weight |
| No. | (g) | (g) | (g) | (g/m²) |
| Comparative | 79.28 | — | — | — |
| Sample 1 | | | | |
| Sample 1 | 79.06 | 80.27 | 83.69 | 9.84 |
| Sample 2 | 79.05 | 80.27 | 83.88 | 13.13 |
| Sample 3 | 79.35 | 80.28 | 84.10 | 51.13 |
| Sample 4 | 80.41 | 80.52 | 84.01 | 38.75 |
| Sample 5 | 80.56 | 81.34 | 85.37 | 51.77 |

TABLE 16
Barrier Coating Formulations (based on wt. % solids)

| | Sample 1 | Sample 2 | Sample 3 | Sample 4 | Sample 5 |
|---|---|---|---|---|---|
| PVDC barrier polymer | 99.9 wt. % | 99.8 wt. % | 99.7 wt. % | 99.6 wt. % | 99.5 wt. % |
| Rheology modifier | 0.1 wt. % | 0.2 wt. % | 0.3 wt. % | 0.4 wt. % | 0.5 wt. % |

Thermal conductivity for each Sample was tested in accordance with ASTM C578 (70° F. and 45% relative humidity) on the following interval schedule: Day 7 (k7), Day 20 (k20), Day 30 (k30), Day 60 (k60), Day 120, and Day 180, and the performance is provided below in Table 17.

TABLE 17

| | k-value (Btu · in/h · ft² · ° F.) | | | | | |
|---|---|---|---|---|---|---|
| Sample No. | k7 | k20 | k30 | k60 | k120 | k180 |
| Comparative | 0.1641 | 0.1753 | 0.1806 | 0.1879 | 0.1943 | 0.1981 |
| Sample 1 | | | | | | |
| Sample 1 | 0.1399 | 0.1415 | 0.1421 | 0.1450 | 0.1496 | 0.1534 |
| Sample 2 | 0.1402 | 0.1412 | 0.1433 | 0.1467 | 0.1527 | 0.1568 |
| Sample 3 | 0.1405 | 0.1415 | 0.1434 | 0.1470 | 0.1527 | 0.1566 |
| Sample 4 | 0.1454 | 0.1520 | 0.1558 | 0.1631 | 0.1706 | 0.1753 |
| Sample 5 | 0.1410 | 0.1417 | 0.1434 | 0.1458 | 0.1516 | 0.1555 |

As illustrated in Table 17, the uncoated Comparative Sample demonstrated a thermal conductity k-value of greater than 0.175 BTU·in/h·ft²·° F. as early as day 20 (k20), while each of the inventive Samples coated with the barrier coating composition remained with k-factors below 0.175 BTU·in/h·ft²·° F. after 180 days and below 0.18 Btu·in/h·ft²·° F. after 180 days.

### Example 11

Extruded polystyrene foam samples were prepared using a co-rotating twin screw extrusion foam line. Polystyrene was melted in the extruder and mixed with an injected blowing agent composition to form a homogeneous foamable composition. Each foamable composition was the same, and included 100 wt. % polystyrene, flame retardant masterbatch, and graphite masterbatch. A blowing agent blend comprising about 50 wt. % CO₂ and about 50 wt. % of a blend of an HFO and an HFC, based on the total weight of the blowing agent, was included at a constant recipe and total amount across all foam samples.

The foamable compositions were extruded to produce 1-inch XPS foam samples, each having a density of about 2.3 pcf.

Comparative Sample 2 was left uncoated, while Samples 6 to 10 were coated with an exemplary barrier coating composition on at least one side using a hand sprayer, as outlined in Table 18, below. The barrier coating composition is provided below in Table 19.

TABLE 18

| | Foam Sample | Foam + Coat | Foam + Coat 2 | Final |
|---|---|---|---|---|
| | Wt. | 1 Wt. | Wt. | Coat Wt. |
| Sample No. | (g) | (g) | (g) | (g/m²) |
| Comparative | 75.13 | — | — | — |
| Sample 2 | | | | |
| Sample 6 | 75.28 | 82.35 | 84.24 | 96.44 |
| Sample 7 | 74.55 | 83.54 | 86.96 | 133.6 |
| Sample 8 | 75.49 | 84.89 | 89.45 | 150.3 |
| Sample 9 | 74.95 | 87.00 | 92.93 | 193.5 |
| Sample 10 | 74.60 | 88.78 | 95.70 | 227.1 |

TABLE 19
Barrier Coating Formulation

| | |
|---|---|
| Adjusted pH | 7.03 |
| Barrier Polymer | 94.7 wt. % |
| pH adjuster | 0.95 wt. % |
| defoamer | 0.2 wt. % |
| Non-ionic wetting agent | 0.2 wt. % |
| Rheology modifier | 0.3 wt. % |
| UV absorber | 2.8 wt. % |
| Anti-blocker | 0.95 wt. % |

Thermal conductivity for each Sample was tested in accordance with ASTM C578 (70 F and 45% relative humidity) on the following interval schedule: Day 7 (k7), Day 20 (k20), Day 30 (k30), and Day 60 (k60) and the performance is provided below in Table 20.

TABLE 20

| | |
|---|---|
| Sample | k-value (Btu · in/h · ft² · ° F.) |

| No. | k7 | k20 | k30 | k60 |
|---|---|---|---|---|
| Comparative | 0.1879 | 0.2013 | 0.2050 | 0.2099 |
| Sample 2 | | | | |
| Sample 6 | 0.1707 | 0.1861 | 0.1911 | 0.1986 |
| Sample 7 | 0.1603 | 0.1696 | 0.1749 | 0.1831 |
| Sample 8 | 0.1581 | 0.1609 | 0.1626 | 0.1674 |
| Sample 9 | 0.1584 | 0.1597 | 0.1609 | 0.1623 |
| Sample 10 | 0.1583 | 0.1596 | 0.1608 | 0.1618 |

As illustrated in Table 20, the uncoated Comparative Sample demonstrated a thermal conductity k-value of greater than 0.2 BTU·in/h·ft²·° F. as early as day 20 (k20), while each of the inventive Samples coated with the barrier coating composition remained with k-factors below 0.2 BTU·in/h·ft²·° F., even after 60 days.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A coated insulation product comprising:
a foam product having a first major surface, an opposing second major surface, and a plurality of minor surfaces extending therebetween, the foam product being formed from a foamable composition comprising:
a) a matrix composition; and
b) a blowing agent composition comprising less than 3.5 wt. % of a fluorinated alkene, based on a total weight of the foamable composition; and
a barrier coating present on at least one surface of the foam product in a total amount between 3 g/m² and 225 g/m², the barrier coating being formed from a barrier coating composition comprising:
40 wt. % to 99.9 wt. % of a barrier polymer, based on a total solids content of the barrier coating composition, the barrier polymer having a minimum degree of crystallinity of 10%; and
0.01 wt. % to 60 wt. % of at least one additive, based on a total solids content of the barrier coating composition, wherein the barrier coating composition has a surface tension no greater than 60 mN/m, and wherein the coated insulation product has a 180-day R/in value of at least 4.8.

2. The coated insulation product of claim 1, wherein the blowing agent composition comprises at least 2 wt. % of CO₂ and less than 3 wt. % of a fluorinated alkene, based on the total weight of the foamable composition.

3. The coated insulation product of claim 1, wherein the blowing agent further comprises methyl formate.

4. The coated insulation product of claim 1, wherein the barrier coating composition has a viscosity no greater than 5000 cP at 70% solids.

5. The coated insulation product of claim 1, wherein the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

6. The coated insulation product of claim 1, wherein the barrier polymer has a minimum degree of crystallinity of 30%.

7. The coated insulation product of claim 1, wherein the barrier polymer has a minimum degree of crystallinity of 60%.

8. The coated insulation product of claim 1, wherein the additive comprises a wetting agent, rheology modifier, fire retardant, antiblocking agent, defoaming agent, pH adjuster; UV stabilizer; or mixtures thereof.

9. The coated insulation product of claim 1, wherein the additive includes at least one of:
a rheology modifier present in an amount between 0.01 wt. % and 20 wt. %, based on the total solids content of the barrier coating;
a wetting agent present in an amount between 0.005 wt. % and 8 wt. %, based on the total solids content of the barrier coating; or
a UV stabilizer present in an amount between 0.05 wt. % and 12 wt. %, based on the total solids content of the barrier coating.

10. The coated insulation product of claim 1, wherein the barrier coating comprises, based on a total solids content of the barrier coating:
40 wt. % to 99 wt. % solids of a barrier polymer;
0.01 wt. % to 15 wt. % solids of a rheology modifier;
0 wt. % to 8 wt. % solids of a wetting agent;
0 to 8 wt. % solids of a pH adjuster;
0 to 5 wt. % solids of a flame retardant; and
0.05 wt. % to 12 wt. % solids of at least one UV stabilizer.

11. The coated insulation product of claim 1, wherein the barrier coating has a pH between 3 and 9.

12. A coated polymeric insulation product comprising:
a polymer foam product having a first major surface, an opposing second major surface, and a plurality of minor surfaces extending therebetween, the foam product being formed from a foamable polymer composition comprising:
a) a polymer matrix composition; and
b) a blowing agent composition comprising 3 wt. % or less of a fluorinated alkene and at least 1.5 wt. % CO₂, based on a total weight of the foamable composition; and
a barrier coating present on each surface of the foam product in a total amount between 3 g/m² and 225 g/m², the barrier coating being formed from a barrier coating composition comprising a semi-crystalline polymer and at least one rheology modifier, the barrier coating composition having a surface tension no greater than 20 mN/m above a surface energy of the polymer foam and a viscosity between 50 cP and 5000 cP at 70% solids or less,
wherein the coated insulation product has a 180-day R/in value of at least 4.8 and a compressive strength between 10 and 110 psi, measured in accordance with ASTM C578.

13. The coated polymeric insulation product of claim 12, wherein the blowing agent composition comprises less than 2 wt. % of a fluorinated alkene at least 2.5 wt. % of CO₂, based on the total weight of the foamable composition.

14. The coated insulation product of claim 12, wherein the blowing agent further comprises methyl formate.

15. The coated polymeric insulation product according to claim 12, wherein the barrier coating composition has a viscosity no greater than 5000 cP at 70% solids.

16. The coated polymeric insulation product according to claim 12, wherein the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

17. The coated polymeric insulation product according to claim 12, wherein the barrier polymer has a minimum degree of crystallinity of 30%.

18. The coated polymeric insulation product of claim 12, wherein the rheology modifier is present in an amount between 0.015 wt. % and 20 wt. % solids, based on the total solids content of the barrier coating.

19. The coated polymeric insulation product of claim 12, wherein the barrier coating composition further includes at least one additive, the additive comprising a wetting agent, defoaming agent, pH adjuster, UV stabilizer, fire retardant, antiblocking agent, or mixtures thereof.

20. The coated polymeric insulation product of claim 12, wherein the barrier coating comprises, based on a total solids content of the barrier coating:
40 wt. % to 99 wt. % solids of a barrier polymer;
0.01 wt. % to 20 wt. % solids of a rheology modifier;
0 wt. % to 8 wt. % solids of a wetting agent;
0 wt. % to 8 wt. % solids of a pH adjuster;
0 to 5 wt. % solids of a fire retardant; and
0.05 wt. % to 12 wt. % solids of at least one UV stabilizer.

21. The coated polymeric insulation product of claim 12, wherein the coated polymeric insulation product has an R-value after 180 days of at least 5.0 per inch.

22. A sheathing system comprising:
at least one structural portion, having a first surface and an opposing second surface; and
at least one coated insulation product adhered to one of the first or second surfaces of the structural portion, the coated insulation product comprising:
a foam product having a first major surface, an opposing second major surface, and four minor surfaces extending therebetween, the foam product being formed from a foamable composition comprising:
a) a matrix composition; and
b) a blowing agent composition comprising less than 3.5 wt. % of a fluorinated alkene, based on a total weight of the foamable composition; and
a barrier coating present on at least one surface of the foam product in a total amount between 3 g/m² and 225 g/m², the barrier coating being formed from a barrier coating composition comprising:
40 wt. % to 99.9 wt. % of a barrier polymer, based on a total solids content of the barrier coating composition, the barrier polymer having a minimum degree of crystallinity of 10%; and
0.1 wt. % to 60 wt. % of at least one additive, based on a total solids content of the barrier coating composition, wherein the barrier coating composition has a surface tension no greater than 60 mN/m, and wherein the coated insulation product has a 180-day R/in value of at least 4.8.

23. The sheathing system of claim 22, wherein the blowing agent composition comprises at least 2.5 wt. % of CO₂ and less than 2 wt. % of a fluorinated alkene, based on the total weight of the foamable composition.

24. The sheathing system of claim 22, wherein the blowing agent further comprises methyl formate.

25. The sheathing system of claim 22, wherein the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

26. The sheathing system of claim 22, wherein the barrier coating comprises, based on a total solids content of the barrier coating:
40 wt. % to 99 wt. % solids of a barrier polymer;
0.01 wt. % to 15 wt. % solids of a rheology modifier;
0 wt. % to 8 wt. % solids of a wetting agent;
0 to 8 wt. % solids of a pH adjuster;
0 to 5 wt. % of a fire retardant; and
0.05 wt. % to 12 wt. % solids of at least one UV stabilizer.

27. A method of manufacturing a coated insulation product with reduced fluorinated blowing agent content, comprising:
mixing a matrix polymer with 2.5 wt. % to 6.5 wt. % of a blowing agent composition to form a foamable polymer composition, the blowing agent composition comprising less than 3.5 wt. % of a fluorinated alkene, based on a total weight of the foamable composition;
foaming the foamable polymer composition to produce a foam product having a first major surface, an opposing second major surface, and four minor surfaces extending therebetween; and
applying a barrier coating to at least one surface of the foam product in a total amount between 3 g/m² and 225 g/m², the barrier coating being formed from a barrier coating composition comprising:
40 wt. % to 99.9 wt. % of a barrier polymer, based on a total solids content of the barrier coating composition, the barrier polymer having a minimum degree of crystallinity of 10%; and
0.01 wt. % to 60 wt. % of at least one additive, based on a total solids content of the barrier coating composition, wherein the barrier coating composition has a surface tension no greater than 40 mN/m, and wherein the coated insulation product has a 180-day R/in value of at least 4.8.
